(19) United States
(12) Patent Application Publication
(10) Pub. No.: US 2013/0285870 A1
(43) Pub. Date: Oct. 31, 2013

(54) ANTENNA APPARATUS AND ELECTRONIC DEVICE INCLUDING ANTENNA APPARATUS

(71) Applicant: KABUSHIKI KAISHA TOSHIBA, Tokyo (JP)

(72) Inventors: Hiroyuki Hotta, Ome-shi (JP); Koichi Sato, Tachikawa-shi (JP); Ippei Kashiwagi, Fuchu-shi (JP)

(73) Assignee: Kabushiki Kaisha Toshiba, Tokyo (JP)

(21) Appl. No.: 13/771,484

(22) Filed: Feb. 20, 2013

(30) Foreign Application Priority Data
Apr. 26, 2012 (JP) 2012-101759

(51) Int. Cl. H01Q 5/00

(52) U.S. Cl. CPC H01Q 5/001
USPC 343/843

(57) ABSTRACT

According to one embodiment, an antenna apparatus includes a first antenna element, a second antenna element, and a third antenna element. The first antenna element has one end connected to a feed terminal, and other end open. The second antenna element has one end connected to a first position set on an element of the first antenna element, and other end open, with a portion between one end and the other end being disposed parallel to the first antenna element. The third antenna element has one end connected to a second position set between the other end and the first position on the element of the first antenna element, and other end open, with at least part of a portion between one end and the other end being disposed near the second antenna element.

### CROSS-REFERENCE TO RELATED APPLICATIONS

This application is based upon and claims the benefit of priority from Japanese Patent Application No. 2012-101759, filed Apr. 26, 2012, the entire contents of which are incorporated herein by reference.

### FIELD

Embodiments described herein relate generally to an antenna apparatus and an electronic device including the antenna apparatus.

### BACKGROUND

Recently, the housings of portable terminal devices typified by cellular phones, smartphones, personal digital assistants (PDAs), electronic book readers, and the like have been required to have reduced dimensions and weight from the viewpoint of compactness and lightness. Accordingly, demands have arisen for more compact antenna apparatuses. It has also been required to allow a single portable terminal device to communicate with a plurality of radio systems using different frequency bands.

Under the circumstances, conventionally, for example, a multifrequency antenna apparatus has been proposed, which has the second antenna element formed from a monopole element provided at a position near the feed point of the first antenna element formed from, for example, a folded element with a stub in a direction opposite to the first antenna element. This multifrequency antenna apparatus achieves size reduction of the antenna apparatus by covering a low-frequency band (for example, the 800-MHz band) with the folded element with the stub and also covering a high-frequency band (for example, the 2-GHz band) with the monopole element.

However, further reducing the distance between the folded element and the monopole element to further miniaturize (reduce the height and width) the antenna apparatus will decrease the impedance of the monopole element and make it impossible to obtain satisfactory antenna characteristics.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view showing the arrangement of an electronic device including an antenna apparatus according to the first embodiment;

FIG. 2 is a view for explaining the operation of the antenna apparatus shown in FIG. 1;

FIG. 3 is a view for explaining the operation of the antenna apparatus shown as a reference example;

FIG. 4 is a view showing an example of the antenna apparatus shown in FIG. 1;

FIG. 5 is a view showing a reference example to be compared with the antenna apparatus shown in FIG. 4;

FIG. 6 is a Smith chart showing the antenna characteristics of the embodiment shown in FIG. 4 in comparison with those of the reference example shown in FIG. 5;

FIG. 7 is a graph showing the VSWR frequency characteristic of the embodiment shown in FIG. 4 in comparison with that of the reference example shown in FIG. 5;

FIG. 8 is a view showing the arrangement of an antenna apparatus according to the second embodiment;

FIG. 9 is a view showing an example of the antenna apparatus shown in FIG. 8;

FIG. 10 is a view showing a reference example to be compared with the antenna apparatus shown in FIG. 9;

FIG. 11 is a Smith chart showing the antenna characteristics of the embodiment shown in FIG. 9 and those of the reference example shown in FIG. 10;

FIG. 12 is a graph showing the VSWR frequency characteristic of the embodiment shown in FIG. 9 in comparison with that of the reference example shown in FIG. 10;

FIG. 13 is a view for explaining an example of the embodiment shown in FIG. 4;

FIG. 14 is a graph showing the VSWR frequency characteristic of the example shown in FIG. 13;

FIG. 15 is a view showing the arrangement of an antenna apparatus according to the third embodiment;

FIG. 16 is a view showing an example of the antenna apparatus shown in FIG. 15;

FIG. 17 is a view showing a reference example to be compared with the antenna apparatus shown in FIG. 16;

FIG. 18 is a Smith chart showing the antenna characteristics of the embodiment shown in FIG. 16 in comparison with those of the reference example shown in FIG. 17;

FIG. 19 is a graph showing the VSWR frequency characteristic of the embodiment shown in FIG. 16 in comparison with that of the reference example shown in FIG. 17;

FIG. 20 is a view showing the arrangement of an antenna apparatus according to the four embodiment;

FIG. 21 is a view showing an example of the antenna apparatus shown in FIG. 20;

FIG. 22 is a view showing a reference example to be compared with the antenna apparatus shown in FIG. 21;

FIG. 23 is a Smith chart showing the antenna characteristics of the embodiment shown in FIG. 21 in comparison with those of the reference example shown in FIG. 22;

FIG. 24 is a view showing the VSWR frequency characteristic of the embodiment shown in FIG. 21 in comparison with that of the reference example shown in FIG. 22;

FIG. 25 is a view for explaining an example of the embodiment shown in FIG. 15;

FIG. 26 is a graph showing the VSWR frequency characteristic of the example shown in FIG. 25;

FIG. 27 is a view showing the arrangement of an antenna apparatus according to the fifth embodiment;

FIG. 28 is a view showing an example of the antenna apparatus shown in FIG. 27;

FIG. 29 is a view showing a reference example to be compared with the antenna apparatus shown in FIG. 28;

FIG. 30 is a Smith chart showing the antenna characteristics of the embodiment shown in FIG. 21 in comparison with those of the reference example shown in FIG. 22;

FIG. 31 is a graph showing the VSWR frequency characteristic of the embodiment shown in FIG. 21 in comparison with that of the reference example shown in FIG. 22;

FIG. 32 is a view showing the arrangement of an antenna apparatus according to the sixth embodiment;

FIG. 33 is a view showing an example of the antenna apparatus shown in FIG. 32;

FIG. 34 is a view showing a reference example to be compared with the antenna apparatus shown in FIG. 33;

FIG. 35 is a Smith chart showing the antenna characteristics of the embodiment shown in FIG. 33 in comparison with those of the reference example shown in FIG. 34;

FIG. 36 is a graph showing the VSWR frequency characteristic of the embodiment shown in FIG. 33 in comparison with that of the reference example shown in FIG. 34;

FIG. 37 is a view for explaining an example of the embodiment shown in FIG. 32;

FIG. 38 is a graph showing the VSWR frequency characteristic of the example shown in FIG. 37;

FIG. 39 is a view showing another example of the embodiment shown in FIG. 32;

FIG. 40 is a view showing the arrangement of an antenna apparatus (monopole type) according to the seventh embodiment;

FIG. 41 is a view showing an example of the antenna apparatus shown in FIG. 40;

FIG. 42 is a graph showing the VSWR frequency characteristic of the antenna apparatus shown in FIG. 41 in comparison with that of an antenna apparatus without any parasitic element;

FIG. 43 is a view showing the arrangement of an antenna apparatus (inverted F type) according to the eighth embodiment;

FIG. 44 is a view showing an example of the antenna apparatus shown in FIG. 43;

FIG. 45 is a graph showing the VSWR frequency characteristic of the antenna apparatus shown in FIG. 44 in comparison with that of an antenna apparatus without any parasitic element;

FIG. 46 is a view showing the arrangement of an antenna apparatus (folded type) according to the ninth embodiment;

FIG. 47 is a view showing Example 1 of the antenna apparatus shown in FIG. 46;

FIG. 48 is a graph showing the VSWR frequency characteristic of the antenna apparatus shown in FIG. 47 in comparison with that of an antenna apparatus without any parasitic element;

FIG. 49 is a view showing Example 2 of the antenna shown in FIG. 46;

FIG. 50 is a Smith chart showing the antenna characteristics of Example 2 shown in FIG. 49;

FIG. 51 is a graph showing the VSWR frequency characteristic of Example 2 shown in FIG. 49;

FIG. 52 is a view showing the arrangement of an antenna apparatus (monopole type) according to the tenth embodiment;

FIG. 53 is a view showing the arrangement of an antenna apparatus (inverted F type) according to the eleventh embodiment;

FIG. 54 is a view showing the arrangement of an antenna apparatus (folded type) according to the twelfth embodiment;

FIGS. 55A, 55B, 55C, 55D, 55E, and 55F are views showing a plurality of different modifications of the first antenna element of the antenna apparatus shown in FIG. 1;

FIGS. 56A, 56B, 56C, 56D, 56E, 56F, 56G, 56H, 56I, 56J, 56K, 56L, 56M, 56N, and 56O are views showing a plurality of different modifications of the second antenna element of the antenna apparatus shown in FIG. 1;

FIGS. 57A, 57B, 57C, 57D, and 57E are views showing a plurality of different modifications of the branch element of the antenna apparatus shown in FIG. 1;

FIGS. 58A, 58B, 58C, 58D, 58E, 58F, and 58G are views showing a plurality of different modifications of the shorting element of the antenna apparatus shown in FIG. 15;

FIGS. 59A, 59B, 59C, 59D, 59E, 59F, 59G, 59H, 59I, 59J, 59K, and 59L are views showing a plurality of different modifications of the folded element of the antenna apparatus shown in FIG. 27; and

FIGS. 60A and 60B are views showing other modifications of the antenna apparatuses shown in FIGS. 1 and 27.

### DETAILED DESCRIPTION

Various embodiments will be described hereinafter with reference to the accompanying drawings.

In general, according to one embodiment, an antenna apparatus of the embodiment includes a first antenna element, a second antenna element, and a third antenna element. The first antenna element has one end connected to a feed terminal, and other end open, with an element length from one end to the other end being set to substantially ¼ a wavelength corresponding to a preset first resonant frequency. The second antenna element has one end connected to a first position set on an element of the first antenna element, and other end open, with a portion between one end and the other end being disposed parallel to the first antenna element, and an element length from the one end to the other end being set to substantially ¼ a wavelength corresponding to a preset second resonant frequency. The third antenna element has one end connected to a second position set between the other end and the first position on the element of the first antenna element, and other end open, with at least part of a portion between one end and the other end being disposed near the second antenna element.

According to this embodiment, the first current flows from the feed terminal of the second antenna element to the open end during the operation of the apparatus. In contrast to this, the second current opposite in phase to the first current flows from the open end to a feed terminal 4. In addition, since the first antenna element is provided with the third antenna element, the third current having a reverse phase flows from the open end of the third antenna element to the feed terminal via the first antenna element. That is, the third current flows in the first antenna element in addition to the second current. As a consequence, the degree of cancellation between these currents greatly increases at the feed terminal. This makes it possible to increase the resonance impedance of the second antenna element, leading to a decrease in the resonant frequency of the second antenna element.

That is, it is possible to provide an antenna apparatus which can improve the resonance impedance characteristic of the antenna element covering the high-frequency band and lower the resonant band, thereby achieving further miniaturization of the antenna apparatus, and an electronic device including the antenna apparatus.

### First Embodiment

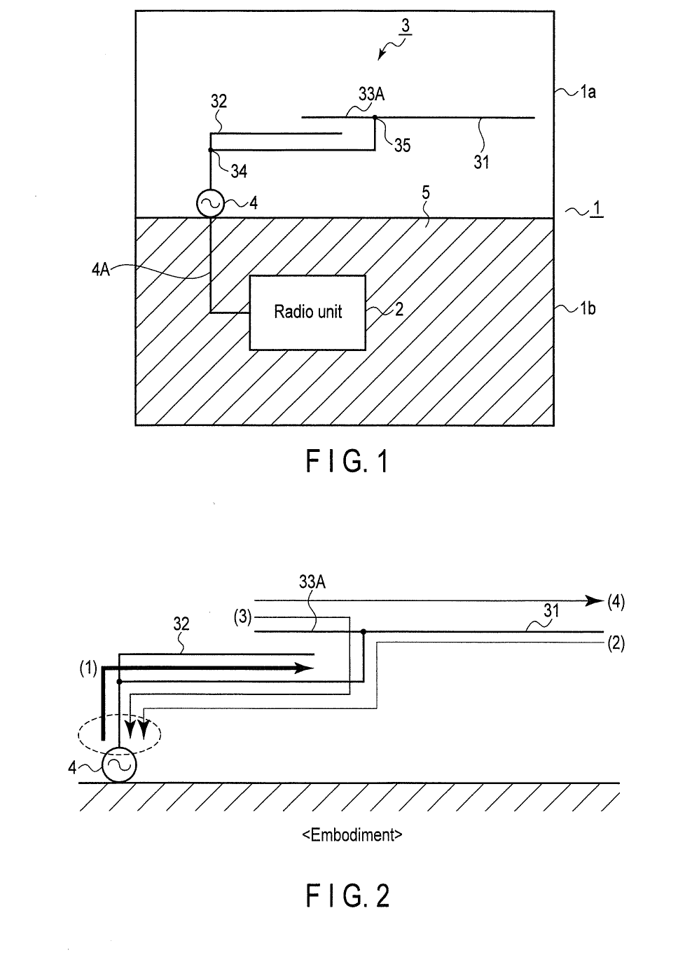

FIG. 1 is a view showing the arrangement of the main part of an electronic device including an antenna apparatus according to the first embodiment. This electronic device is formed from a notebook personal computer or touch panel type portable information terminal including a radio interface, and includes a printed circuit board 1. Note that the electronic device may be another portable terminal device such as a cellular phone, smartphone, PDA (Personal Digital Assistant), electronic book, or game terminal instead of a portable information terminal such as a notebook personal computer or touch panel type portable information terminal. The printed circuit board 1 may serve as part of a metal housing or formed from a metal member such as a copper foil.

The printed circuit board 1 has a first area 1a and a second area 1b. The first area 1a is provided with an antenna apparatus 3. A ground pattern 5 is formed in the second area 1b. Note that a plurality of circuit modules necessary to form the electronic device are amounted on the rear surface side of the printed circuit board 1. The circuit modules include a radio unit 2. The radio unit 2 has a function of transmitting and receiving radio signals by using the channel frequency assigned to a radio system as a communication target. The first area 1a is also provided with a feed terminal 4. The radio unit 2 is connected to the feed terminal 4 via a feed pattern or a feed cable 4A.

The antenna apparatus 3 has the following arrangement.

That is, the antenna apparatus 3 includes a first antenna element 31 formed from a monopole element, a second antenna element 32 formed from a monopole element, and a branch element 33A serving as the third antenna element.

The first antenna element 31 is folded into a crank shape and has one end connected to the feed terminal 4, and the other end open. The element length of the first antenna element 31 is set to ¼ a wavelength corresponding to a preset first resonant frequency f1. The first resonant frequency f1 is set to, for example, a band (700 to 900 MHz) used by a radio system using LTE (Long Term Evolution).

The second antenna element 32 is folded into an L shape and has one end connected to a first folding point (to be referred to as a parallel connection point hereinafter) 34 of the first antenna element 31, and the other end open. The second antenna element 32 is disposed such that a portion parallel to a side of the ground pattern 5 becomes parallel to the first antenna element 31. The element length of the second antenna element 32 is set to ¼ a wavelength corresponding to a preset second resonant frequency f2. The second resonant frequency f2 is set to, for example, a band (1.7 to 1.9 GHz) used by a radio system conforming to the 3G standard.

The branch element 33A is formed from a linear element and has one end portion connected to a second folding point (to be referred to as a branching point hereinafter) 35 of the first antenna element 31, and the other end open. The branch element 33A is disposed such that its distal end portion is located near and faces the distal end portion of the second antenna element 32.

With this arrangement, when the antenna apparatus operates in the band of the second resonant frequency f2, the following currents flow in the antenna elements 31 to 33A during the operation of the antenna apparatus. FIG. 2 shows an example of how the currents flow. That is, a current (1) flows in the second antenna element 32 from the feed terminal 4 to the open end. In contrast to this, a current (2) opposite in phase to the current (1) flows in the first antenna element 31 from the open end to the feed terminal 4. Furthermore, providing the branch element 33A for the first antenna element 31 makes a current (3) having a reverse phase flow in the first antenna element 31 from the open end of the branch element 33A to the feed terminal 4 via the first antenna element 31.

That is, in addition to the current (2), the current (3) flows in the first antenna element 31. This increases the degree of cancellation between currents at the feed terminal 4. This can increase the resonance impedance in the second antenna element 32. As a consequence, the resonant frequency of the second antenna element 32 can be decreased.

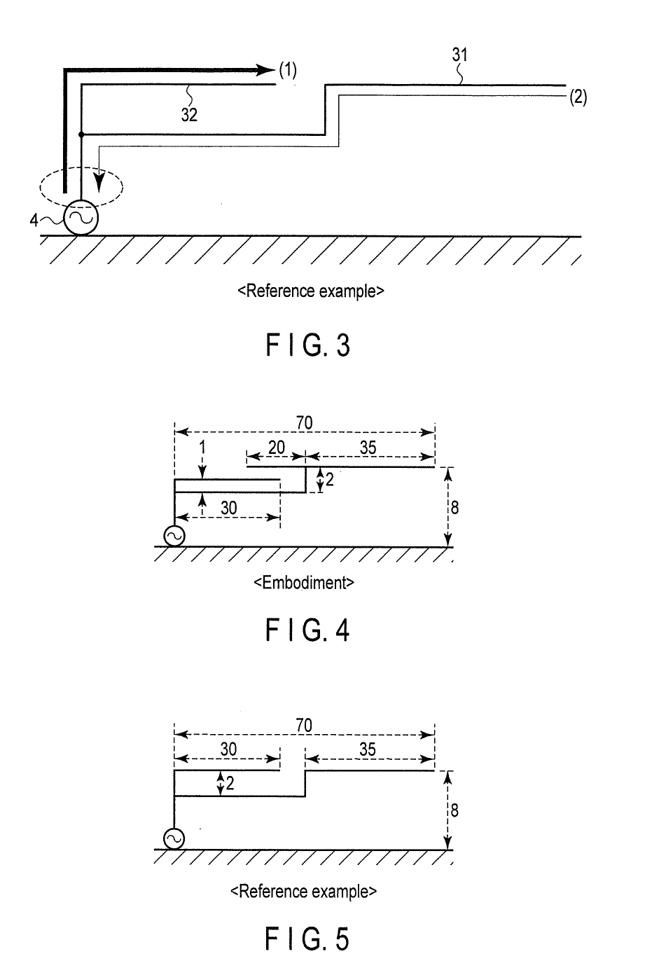

Consider a case without the branch element 33A as a reference example. As shown in FIG. 3, although the current (2) opposite in phase to the current (1) flowing in the second antenna element 32 flows in the first antenna element 31, the current (3) does not flow in the branch element 33A. For this reason, the degree of cancellation of the current (1) decreases as compared with the case shown in FIG. 2. As a result, the resonance impedance of the second antenna element 32 decreases.

### Example 1

FIG. 4 shows an example of the antenna apparatus configured such that the resonant frequency band of the first antenna element 31 is set to 700 to 900 MHz, and the resonant frequency band of the second antenna element 32 is set to 1.7 to 1.9 GHz. Referring to FIG. 4, the numbers show the dimensions (unit: mm) of the respective antenna element portions. FIG. 5 shows an arrangement without the branch element 33A as a reference example.

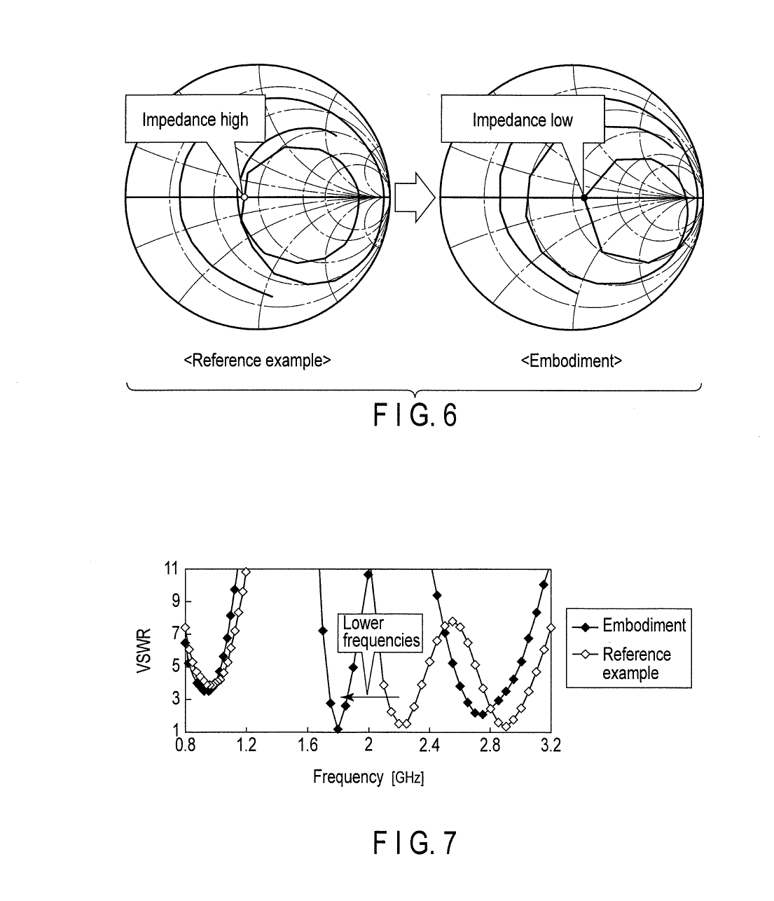

FIG. 6 is a Smith chart showing the antenna characteristics of the example shown in FIG. 4 in comparison with those of the reference example shown in FIG. 5. As is obvious from FIG. 6, according to the example of the first embodiment, providing the branch element 33A and disposing the open end portion of the branch element 33A near a second antenna element 62 can increase the impedance at the resonant frequency of the second antenna element 32 as compared with the reference example.

FIG. 7 shows the VSWR frequency characteristic of an example shown in FIG. 4 in comparison with that of the reference example shown in FIG. 5. As is obvious from FIG. 7, according to the example of the first embodiment, it is possible to lower the resonant frequency band of the second antenna element 32 as compared with the reference example. Decreasing the resonant frequency in this manner can further shorten the element length of the second antenna element 32 and achieve further miniaturization of the antenna apparatus.

### Second Embodiment

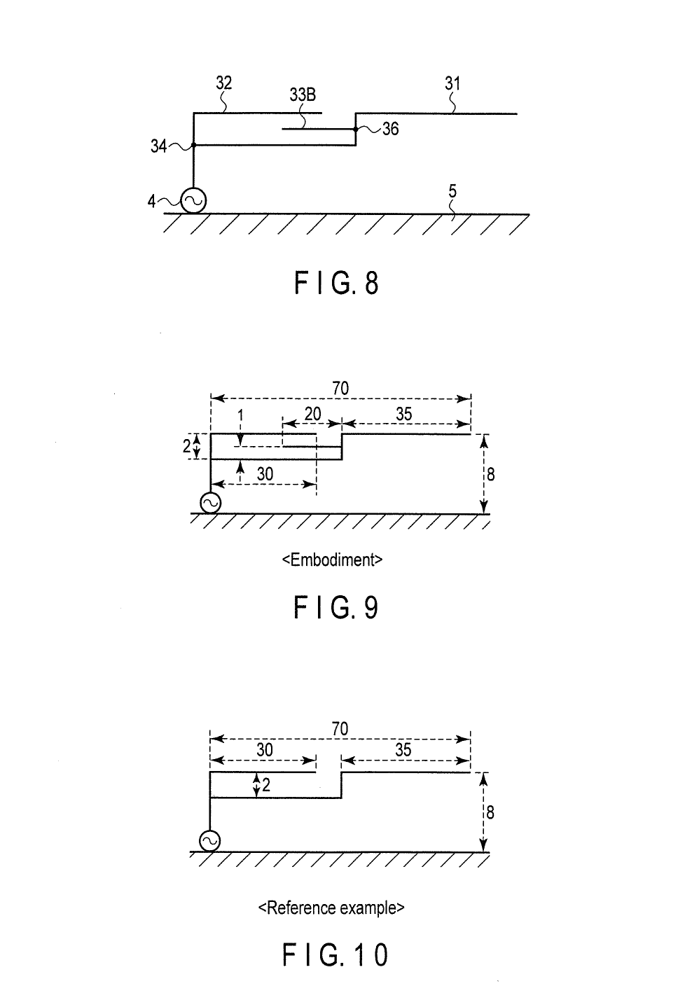

FIG. 8 shows the arrangement of an antenna apparatus according to the second embodiment. Note that the same reference numbers as in FIG. 8 denote the same parts in FIG. 1, and a detailed description of them will be omitted.

Referring to FIG. 8, a branch element 33B branches off from a branching point 36 provided on the vertical portion of a first antenna element 31. The open end portion of the branch element 33B is disposed between the first antenna element 31 and a second antenna element 32 so as to face and be close to them.

### Example 1

FIG. 9 shows an example of an antenna apparatus configured such that the resonant frequency band of the first antenna element 31 is set to 700 to 900 MHz, and the resonant frequency band of the second antenna element 32 is set to 1.7 to 1.9 GHz. Referring to FIG. 9, the numbers show the dimensions (unit: mm) of the respective antenna element portions. FIG. 10 shows an arrangement without the branch element 33B as a reference example.

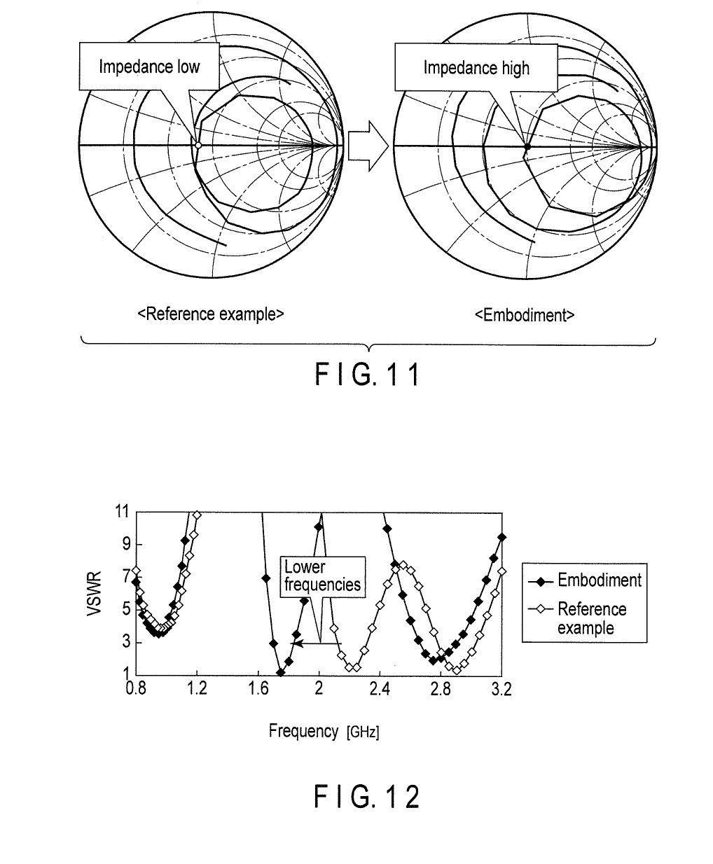

FIG. 11 is a Smith chart showing the antenna characteristics of the example shown in FIG. 9 in comparison with those of the reference example shown in FIG. 10. As is obvious from FIG. 11, according to Example 1 of the second embodiment, it is possible to increase the impedance at the resonant frequency of the second antenna element 32 as compared with the reference example.

FIG. 12 shows the VSWR frequency characteristic of Example 1 shown in FIG. 9 in comparison with that of the reference example shown in FIG. 10. As is obvious from FIG. 12, according to Example 1 of the second embodiment, it is possible to lower the resonant frequency band of the second antenna element 32. This can further shorten the element length of the second antenna element 32 and achieve further miniaturization of the antenna apparatus.

### Example 2

In the antenna apparatuses according to the first and second embodiments, it is possible to variably change the resonant frequencies of the second antenna elements 32 by variably setting the lengths of the portions of the branch elements 33A and 33B which face the second antenna elements 32.

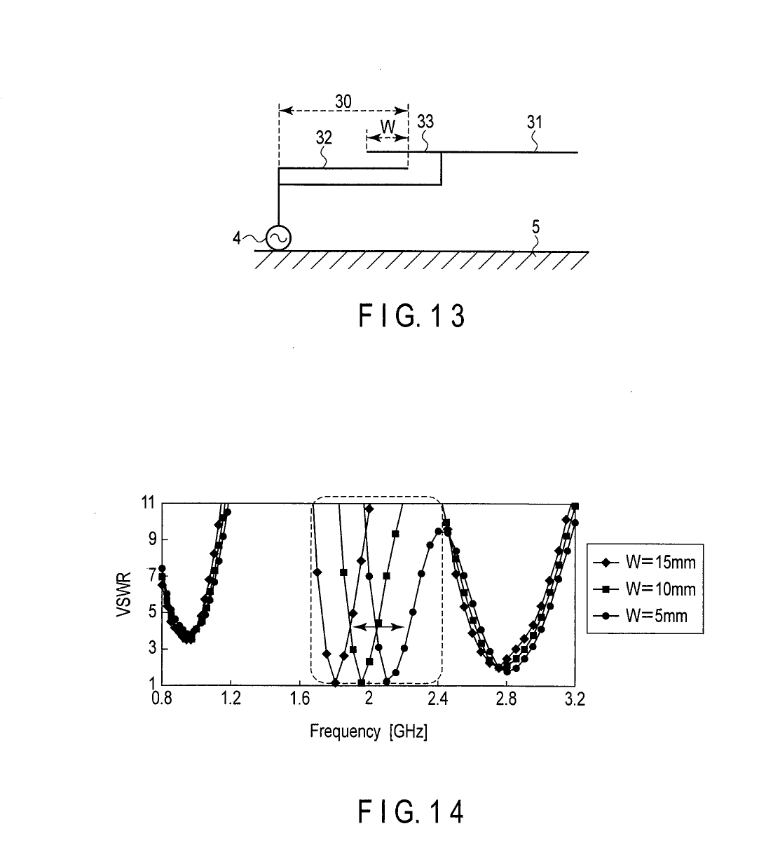

FIG. 13 shows Example 2 of the first embodiment. Referring to FIG. 13, assume that a length W of the portion of the branch element 33A which faces the second antenna element 32 is set to three different values, for example, W=15 mm, W=10 mm, and W=5 mm. In this case, when VSWR frequency characteristics are measured, the results shown in FIG. 14 are obtained. As is obvious from these measurement results, as the length W of the parallel portion increases, it is possible to shift the resonant frequency of the second antenna element 32 to a lower value.

Note that it is possible to variably setting the resonant frequency of the second antenna element 32 by variably changing the length W of the portion of the branch element 33B which is parallel to the second antenna element 32 in the same manner as described above in the second embodiment.

### Third Embodiment

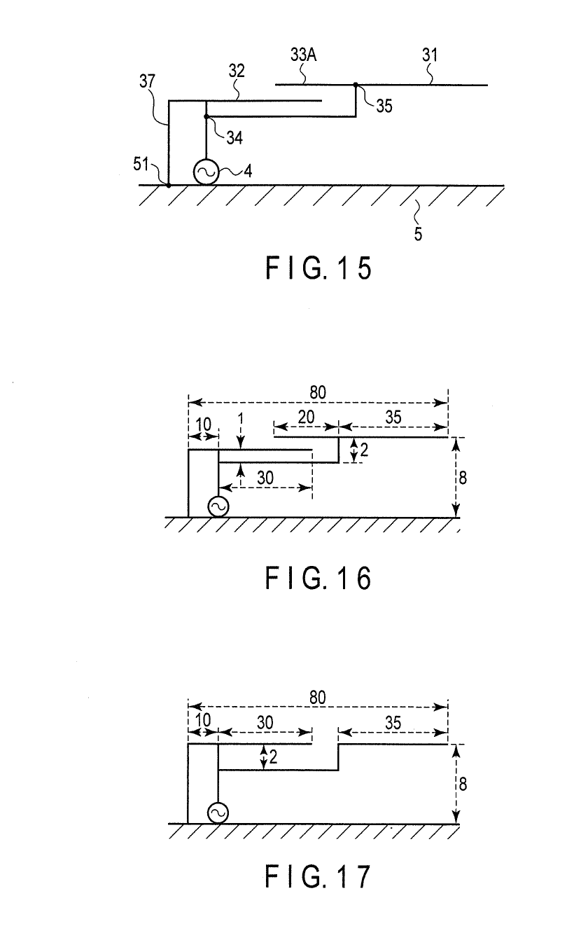

FIG. 15 shows the arrangement of an antenna apparatus according to the third embodiment. Note that the same reference numbers as in FIG. 15 denote the same parts in FIG. 1, and a detailed description of them will be omitted.

Referring to FIG. 15, a shorting element 37 is connected in parallel to a first antenna element 31. The shorting element 37 has an L shape, with one end being connected to a ground terminal 51 and the other end being connected to a parallel connection point 34 or its nearby position. The shorting element 37 is disposed parallel to the portion between a feed terminal 4 of the first antenna element 31 and the parallel connection point 34. That is, the first antenna element 31 and the shorting element 37 constitute an inverted F-type antenna element. Note that a branch element 33A is connected to a branching point 35 provided in the middle of the first antenna element 31 as in the first embodiment.

### Example 1

FIG. 16 shows an example of the antenna apparatus configured such that the resonant frequency band of the first antenna element 31 is set to 700 to 900 MHz, and the resonant frequency band of a second antenna element 32 is set to 1.7 to 1.9 GHz. Referring to FIG. 16, the numbers show the dimensions (unit: mm) of the respective antenna element portions. FIG. 17 shows an arrangement without the branch element 33A as a reference example.

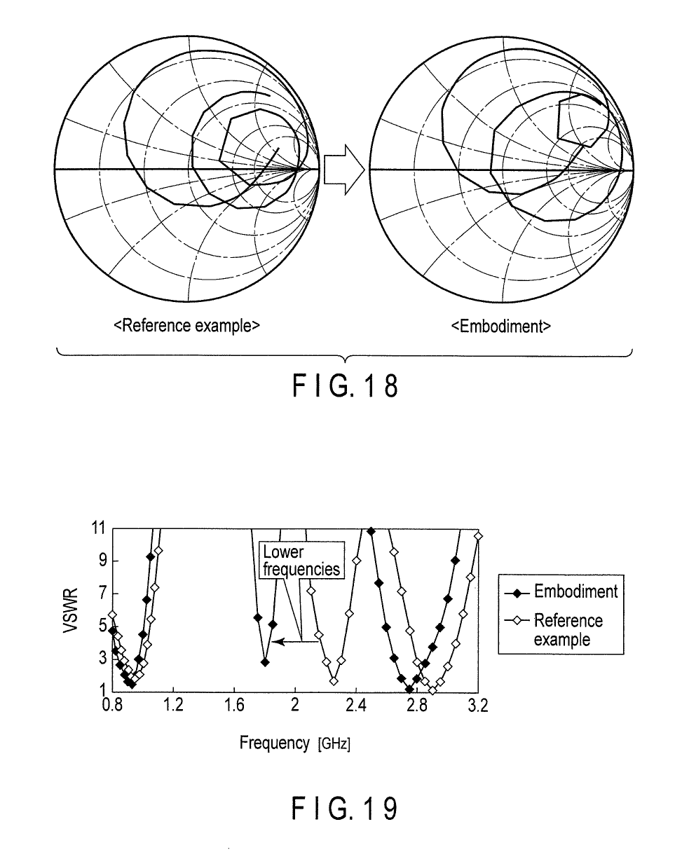

FIG. 18 is a Smith chart showing the antenna characteristics of the example shown in FIG. 16 in comparison with those of the reference example shown in FIG. 17. As is obvious from FIG. 17, according to Example 1 of the third embodiment, it is possible to increase the impedance at the resonant frequency of the second antenna element 32 as compared with the reference example as in the first embodiment described above.

FIG. 19 shows the VSWR frequency characteristic of Example 1 shown in FIG. 16 in comparison with that of the reference example shown in FIG. 17. As is obvious from FIG. 19, according to Example 1 of the third embodiment, it is possible to lower the resonant frequency band of the second antenna element 32. This can further shorten the element length of the second antenna element 32 and achieve further miniaturization of the antenna apparatus.

### Fourth Embodiment

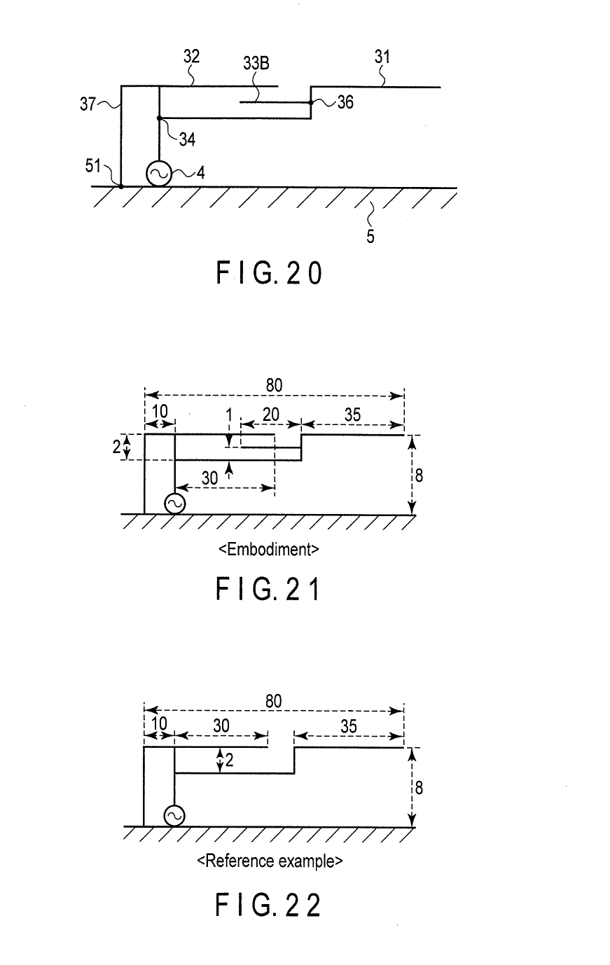

FIG. 20 shows the arrangement of an antenna apparatus according to the fourth embodiment. Note that the same reference numbers as in FIG. 20 denote the same parts in FIG. 15, and a detailed description of them will be omitted.

Referring to FIG. 20, a branch element 33B branches off from a branching point 36 provided on the vertical portion of a first antenna element 31. The open end portion of the branch element 33B is disposed parallel between the first antenna element 31 and the second antenna element 32.

### Example 1

FIG. 21 shows an example of the antenna apparatus configured such that the resonant frequency band of the first antenna element 31 is set to 700 to 900 MHz, and the resonant frequency band of the second antenna element 32 is set to 1.7 to 1.9 GHz. Referring to FIG. 21, the numbers show the dimensions (unit: mm) of the respective antenna element portions. FIG. 22 shows an arrangement without the branch element 33B as a reference example.

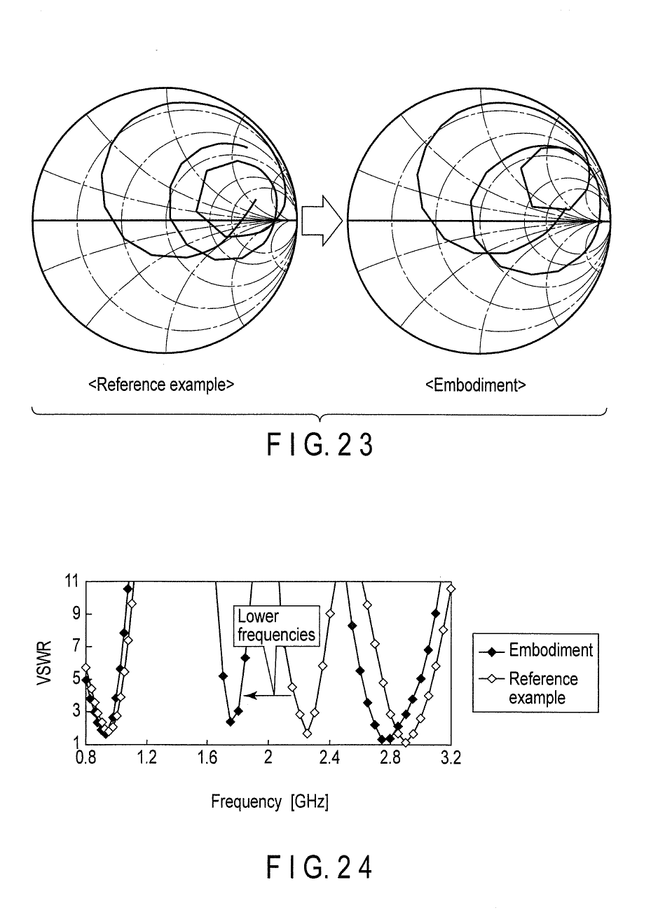

FIG. 23 is a Smith chart showing the antenna characteristics of Example 1 shown in FIG. 21 in comparison with those of the reference example shown in FIG. 22. As is obvious from FIG. 23, according to Example 1 of the fourth embodiment, it is possible to increase the impedance at the resonant frequency of the second antenna element 32 as compared with the reference example as in the third embodiment.

FIG. 24 shows the VSWR frequency characteristic of the example shown in FIG. 21 in comparison with that of the reference example shown in FIG. 22. As is obvious from FIG. 24, according to Example 1 of the fourth embodiment, it is possible to lower the resonant frequency band of the second antenna element 32. This can further shorten the element length of the second antenna element 32 and achieve further miniaturization of the antenna apparatus.

### Example 2

In the antenna apparatuses according to the third and fourth embodiments, it is possible to variably change the resonant frequencies of the second antenna elements 32 by variably setting the lengths of the portions of the branch elements 33A and 33B which face the second antenna elements 32.

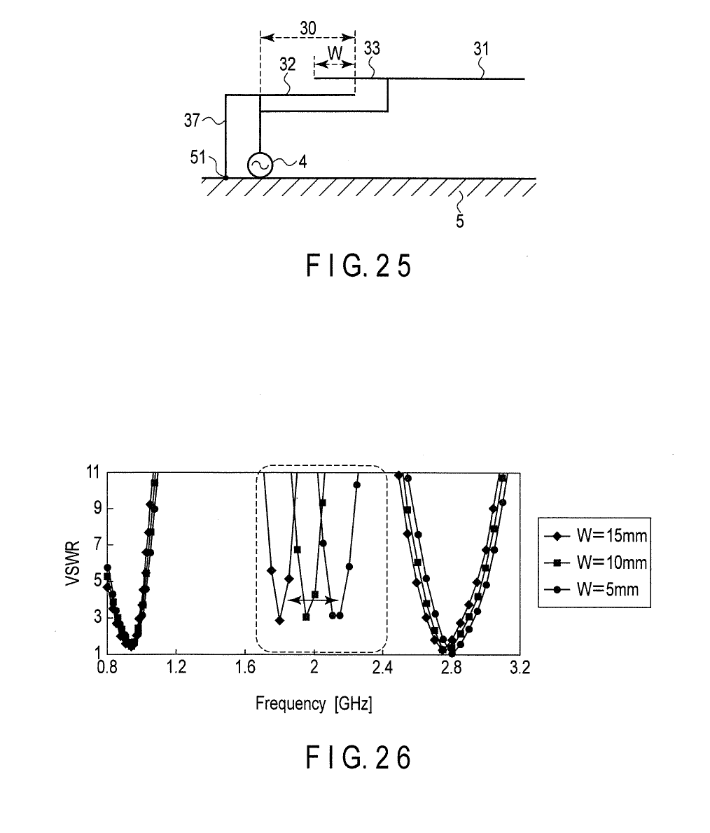

FIG. 25 shows Example 2 of the third embodiment. Referring to FIG. 25, assume that a length W of the portion of the branch element 33A which faces the second antenna element 32 is set to three different values, for example, W=15 mm, W=10 mm, and W=5 mm. In this case, when VSWR frequency characteristics are measured, the results shown in FIG. 26 are obtained. As is obvious from these measurement results, as the length W of the parallel portion increases, it is possible to shift the resonant frequency of the second antenna element 32 to a lower value.

Note that it is possible to variably setting the resonant frequency of the second antenna element 32 by variably changing the length W of the portion of the branch element 33B which is parallel to the second antenna element 32 in the same manner as described above in the fourth embodiment.

### Fifth Embodiment

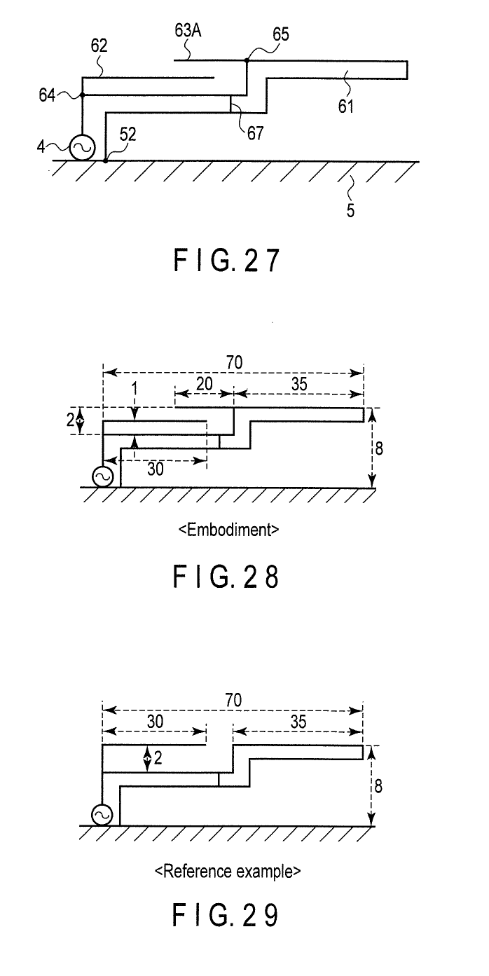

FIG. 27 is a view showing the arrangement of an antenna apparatus according to the fifth embodiment.

This antenna apparatus includes a first antenna element 61 formed from a folded monopole element with a stub, a second antenna element 62 formed from a monopole element, and a branch element 63A.

The first antenna element 61 is formed by folding a linear element into a hairpin shape at a position dividing the entire element into almost two equal portions and further folding a midway portion of the element, folded into the hairpin shape, into a crank shape. One end of the first antenna element 61 is connected to a feed terminal 4 described above, and the other end is connected to a ground terminal 52. A stub 67 is provided between the forward and backward portions formed by the above folding operation. The element length of the first antenna element 61 is set such that the electrical length from the feed terminal 4 to the ground terminal 52 through the folding end becomes nearly ½ a wavelength corresponding to a preset first resonant frequency f1. The distance between the feed terminal 4 and the ground terminal 52 is set to ⅕ or less a wavelength corresponding to the first resonant frequency f1. Note that the first resonant frequency f1 is set to, for example, a band (700 to 900 MHz) used by a radio system using LTE.

The second antenna element 62 is formed into an L shape and has one end connected to a first folding point (to be referred to as a parallel connection point hereinafter) 64 of the first antenna element 61 which is located near the feed terminal 4, and the other end open. The second antenna element 62 is disposed such that a portion parallel to a side of a ground pattern 5 becomes parallel to the first antenna element 61. The element length of the second antenna element 62 is set to ¼ a wavelength corresponding to a preset second resonant frequency f2. The second resonant frequency f2 is set to, for example, a band (1.7 to 1.9 GHz) used by a radio system conforming to the 3G standard.

The branch element 63A is formed from a linear element and has one end connected to a second folding point (to be referred to as a branching point hereinafter) 65 provided at a position on the first antenna element 61 which is sufficiently spaced away from the parallel connection point 64, and the other end open. A portion of the branch element 63A which extends from the open end by a predetermined length is disposed so as to be close to and face a portion of the second antenna element 62 which extends from the open end by a predetermined length.

### Example 1

FIG. 28 shows an example of the antenna apparatus configured such that the resonant frequency band of the first antenna element 61 is set to 700 to 900 MHz, and the resonant frequency band of the second antenna element 62 is set to 1.7 to 1.9 GHz. Referring to FIG. 28, the numbers show the dimensions (unit: mm) of the respective antenna element portions. FIG. 29 shows an arrangement without the branch element 63A as a reference example.

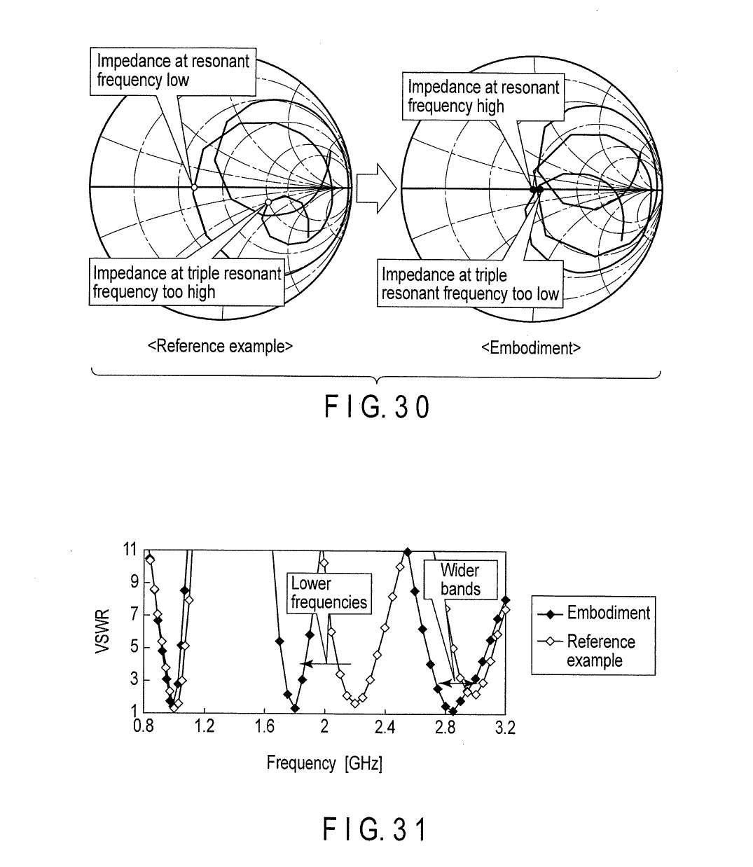

FIG. 30 is a Smith chart showing the antenna characteristics of the example shown in FIG. 28 in comparison with those of the reference example shown in FIG. 29. As is obvious from FIG. 30, according to Example 1 of the fifth embodiment, it is possible to increase the impedance at the resonant frequency of the second antenna element 62 as compared with the reference example by providing the branch element 63A and disposing the portion extending from the open end by the predetermined length at a position near the second antenna element 62. It is also possible to decrease the impedance at the triple resonant frequency of the first antenna element 61 as compared with the reference example.

FIG. 31 shows the VSWR frequency characteristic of Example 1 shown in FIG. 28 in comparison with that of the reference example shown in FIG. 29. As is obvious from FIG. 31, according to Example 1 of the fifth embodiment, it is possible to lower the resonant frequency band of the second antenna element 62. This can further shorten the element length of the second antenna element 62 and achieve further miniaturization of the antenna apparatus. In addition, it is possible to increase the width of the 2.8-GHz resonant band as the triple resonant frequency band of the first antenna element 61.

### Sixth Embodiment

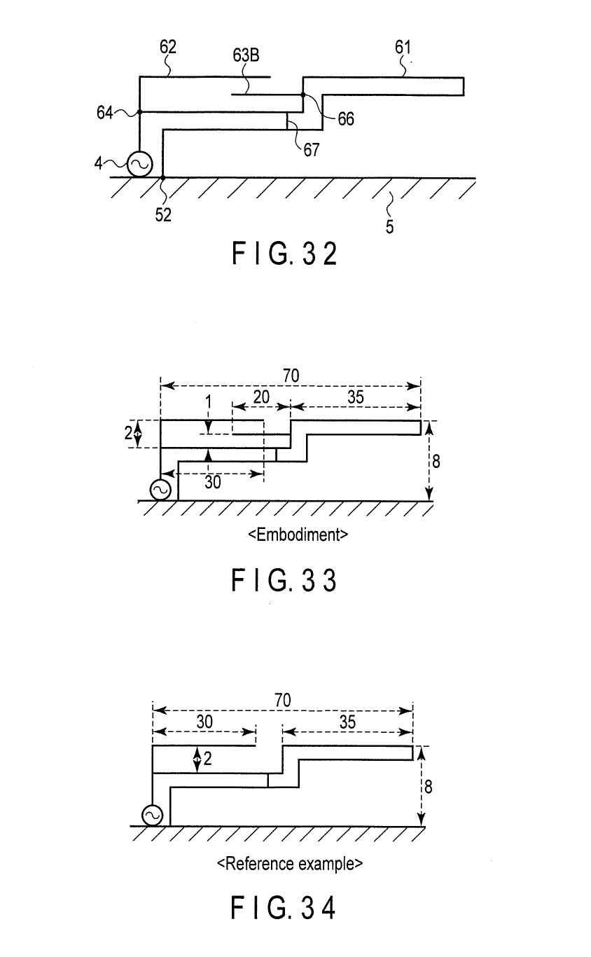

FIG. 32 shows the arrangement of an antenna apparatus according to the sixth embodiment. Note that the same reference numbers as in FIG. 32 denote the same parts in FIG. 1, and a detailed description of them will be omitted.

Referring to FIG. 32, a branch element 63B branches off from a branching point 66 provided on the vertical portion of a first antenna element 61. The branch element 63B is disposed between the first antenna element 61 and a second antenna element 62. A portion of the branch element 63B which extends from the open end by a predetermined length is disposed so as to be close to and face a portion of the second antenna element 62 which extends from the open end by a predetermined length.

### Example 1

FIG. 33 shows an example of the antenna apparatus configured such that the resonant frequency band of the first antenna element 61 is set to 700 to 900 MHz, and the resonant frequency band of the second antenna element 62 is set to 1.7 to 1.9 GHz. Referring to FIG. 33, the numbers show the dimensions (unit: mm) of the respective antenna element portions. FIG. 34 shows an arrangement without the branch element 63B as a reference example.

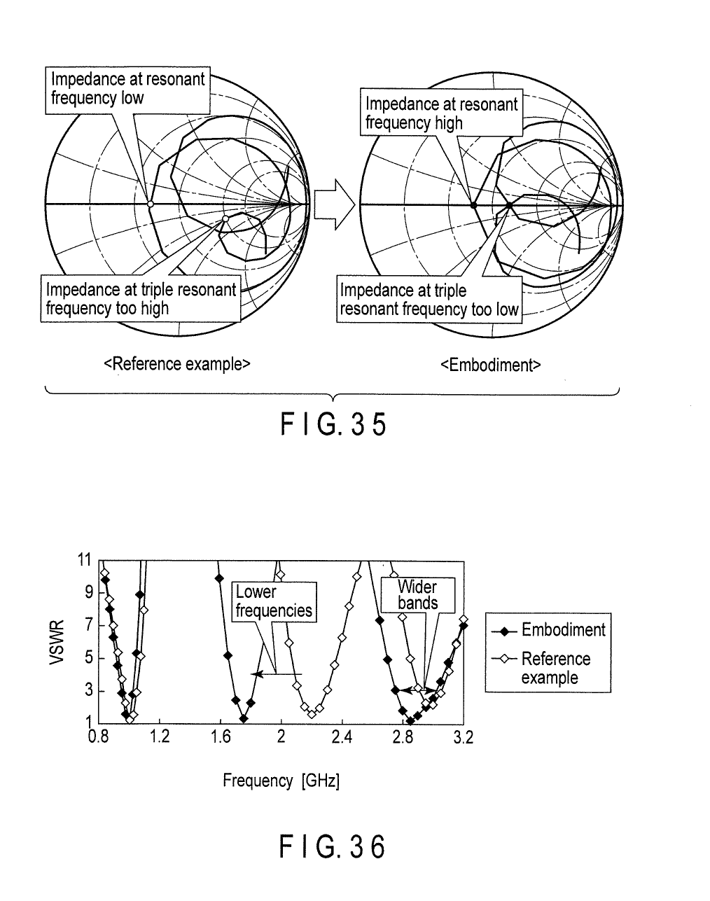

FIG. 35 is a Smith chart showing the antenna characteristics of Example 1 shown in FIG. 33 in comparison with those of the reference example shown in FIG. 34. As is obvious from FIG. 35, according to Example 1 of the sixth embodiment, it is possible to increase the impedance at the resonant frequency of the second antenna element 62 as compared with the reference example as in the fifth embodiment described above. It is also possible to decrease the impedance at the triple resonant frequency of the first antenna element 61 as compared with the reference example.

FIG. 36 shows the VSWR frequency characteristic of Example 1 shown in FIG. 33 in comparison with that of the reference example shown in FIG. 34. As is obvious from FIG. 36, according to Example 1 of the sixth embodiment, it is possible to lower the resonant frequency band of the second antenna element 62. This can further shorten the element length of the second antenna element 62 and achieve further miniaturization of the antenna apparatus. In addition, it is possible to increase the width of the 2.8-GHz resonant band as the triple resonant frequency band of the first antenna element 61.

### Example 2

In the antenna apparatuses according to the fifth and sixth embodiments, it is possible to variably change the resonant frequencies of the second antenna elements 62 by variably setting the lengths of the portions of the branch elements 63A and 63B which face the second antenna elements 62.

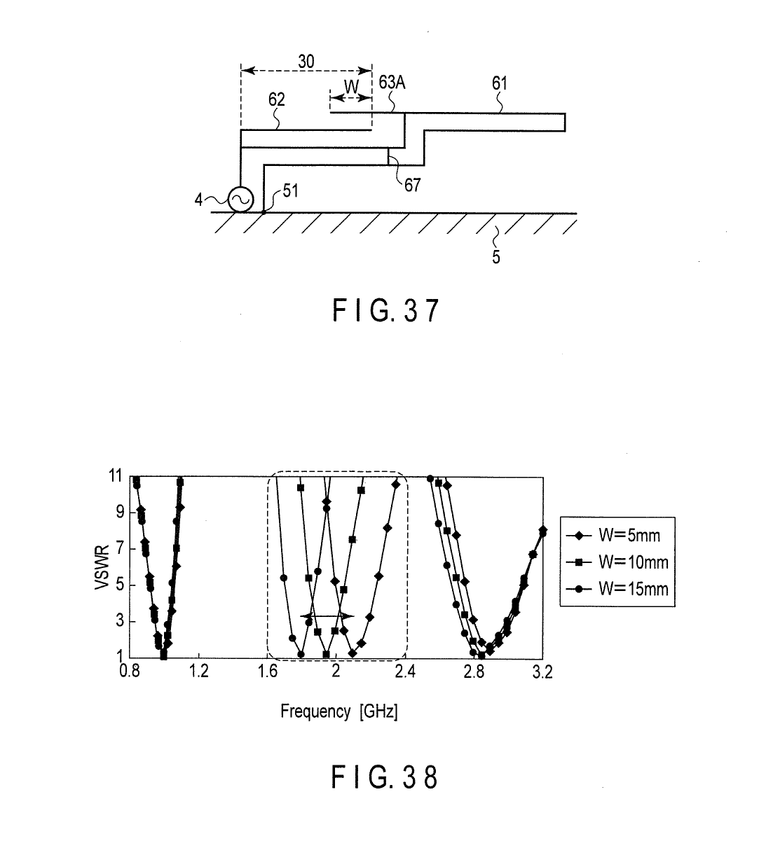

FIG. 37 shows Example 2 of the fifth embodiment. Referring to FIG. 37, assume that a length W of the portion of the branch element 63A which faces the second antenna element 62 is set to three different values, for example, W=15 mm, W=10 mm, and W=5 mm. In this case, when VSWR frequency characteristics are measured, the results shown in FIG. 38 are obtained. As is obvious from these measurement results, as the length W of the parallel portion increases, it is possible to shift the resonant frequency of the second antenna element 62 to a lower value.

Note that it is possible to variably set the resonant frequency of the second antenna element 62 by variably changing the length W of the portion of the branch element 63B which is parallel to the second antenna element 62 in the same manner in the sixth embodiment.

### Example 3

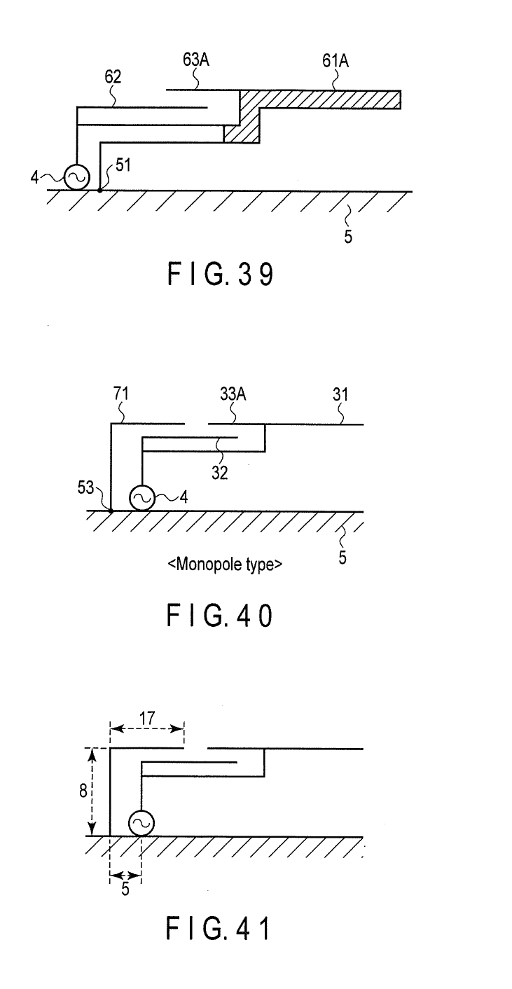

FIG. 39 shows Example 3 of the antenna apparatus shown in FIG. 27. Note that the same reference numbers as in FIG. 39 denote the same parts in FIG. 27, and a detailed description of them will be omitted.

The section from the installation position of the stub of the first antenna element to the folding end is formed from one plate-like element 61A. The element 61A may be formed into a rod-like shape instead of a plate-like shape. Note that the branch element 63A is provided at an intermediate position of the first antenna element 61A as in the case shown in FIG. 27.

With this arrangement, it is possible to simplify the fabrication of the first antenna element 61A formed from a folded monopole element by using a metal sheet in addition to obtaining the effects of increasing the impedance of the second antenna element 62, decreasing the impedance at the triple resonant frequency of the first antenna element 61, and lowering and expanding the resonant frequency band of the second antenna element 62 as described in the fifth and sixth embodiments. In addition, it is possible to increase the structural strength of the section extending from the stub 67 of the first antenna element 61A to the folding end. This can improve the yield in fabricating antenna apparatuses. In addition, this makes it possible to finely adjust the resonant frequency by cutting a distal end portion of the first antenna element 61A as needed.

### Seventh Embodiment

FIG. 40 shows the arrangement of an antenna apparatus according to the seventh embodiment. Note that the same reference numbers as in FIG. 40 denote the same parts in FIG. 1, and a detailed description of them will be omitted.

The antenna apparatus according to the seventh embodiment is configured such that a first antenna element 31 is formed from a monopole element, and a parasitic element 71 is provided near a second antenna element 32 so as to be electrostatically coupled to it. One end of the parasitic element 71 is connected to a ground terminal 53, and the other end is connected to a midway position of the first antenna element 31.

### Example 1

FIG. 41 shows an example of the antenna apparatus configured such that the resonant frequency band of the first antenna element 31 is set to 700 to 900 MHz used by a radio system using LTE, and the resonant frequency band of a second antenna element 32 is set to 1.7 to 1.9 GHz used by a radio system conforming to the 3G standard. Referring to FIG. 41, the numbers show the dimensions (unit: mm) of the respective antenna element portions.

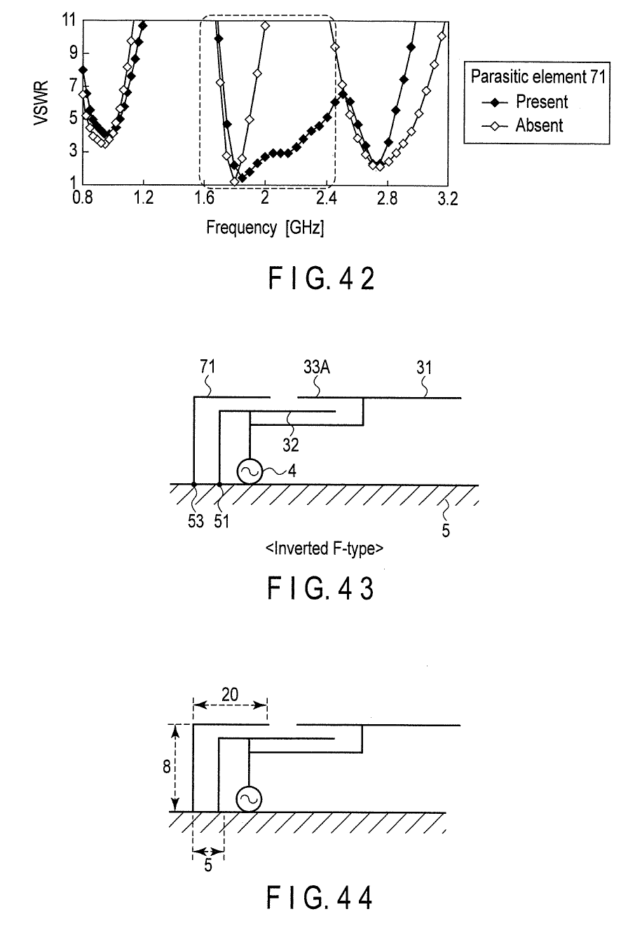

FIG. 42 shows the VSWR frequency characteristic of an example shown in FIG. 41 in comparison with that of an antenna apparatus without the parasitic element 71. As is obvious from FIG. 42, according to the example of the seventh embodiment, it is possible to further expand the resonant frequency band of the second antenna element 32 by disposing the parasitic element 71 near the second antenna element 32 so as to allow the parasitic element 71 to be electrostatically coupled to the second antenna element 32.

### Eighth Embodiment

FIG. 43 shows the arrangement of an antenna apparatus according to the eighth embodiment. Note that the same reference numbers as in FIG. 43 denote the same parts in FIG. 15, and a detailed description of them will be omitted.

The antenna apparatus according to the eighth embodiment is configured such that a first antenna element 31 is formed from an inverted F-type antenna element, and a parasitic element 71 is added and provided near a second antenna element 32 so as to allow the parasitic element 71 to be electrostatically coupled to the second antenna element 32.

### Example 1

As in the seventh embodiment, FIG. 44 shows an example of the antenna apparatus configured such that the resonant frequency band of the first antenna element 31 is set to the band (700 to 900 MHz) used by a radio system using LTE, and the resonant frequency band of the second antenna element 32 is set to the band (1.7 to 1.9 GHz) used by a radio system conforming to the 3G standard. Referring to FIG. 44, the numbers show the dimensions (unit: mm) of the respective antenna element portions.

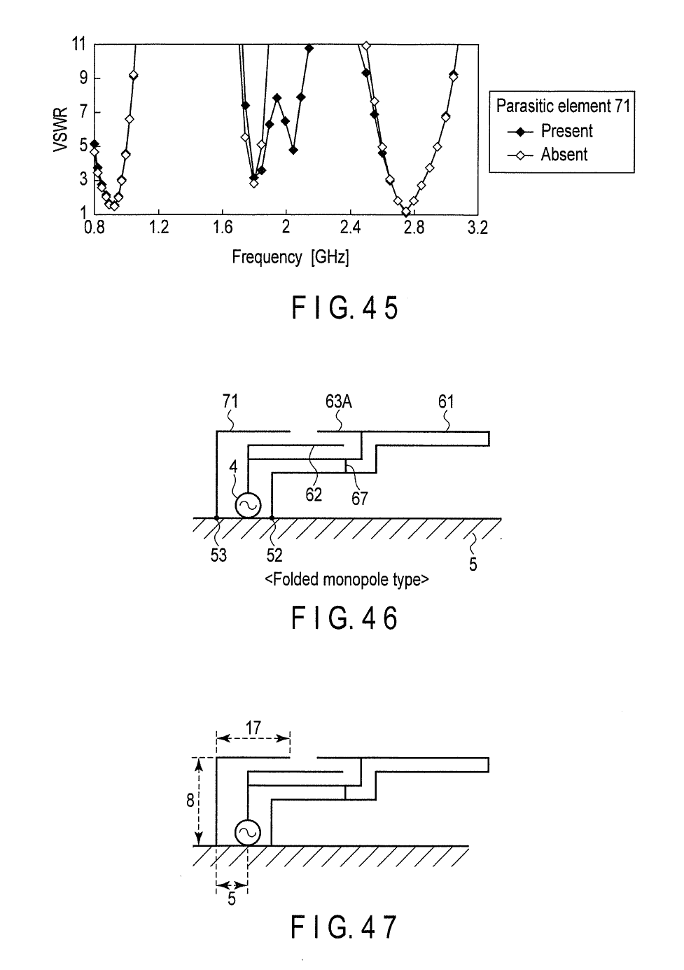

FIG. 45 shows the VSWR frequency characteristic of an example shown in FIG. 44 in comparison with that of an antenna apparatus without the parasitic element 71. As is obvious from FIG. 45, in Example 1 of the eighth embodiment, it is possible to further expand the resonant frequency band of the second antenna element 32 by disposing the parasitic element 71 near the second antenna element 32 so as to allow the parasitic element 71 to be electrostatically coupled to the second antenna element 32.

### Ninth Embodiment

FIG. 46 shows the arrangement of an antenna apparatus according to the ninth embodiment. Note that the same reference numbers as in FIG. 46 denote the same parts in FIG. 27, and a detailed description of them will be omitted.

The antenna apparatus according to the ninth embodiment is configured such that a first antenna element 61 is formed from a folded monopole antenna with a stub, and a parasitic element 71 is added and provided near a second antenna element 62 so as to allow the parasitic element 71 to be electrostatically coupled to the second antenna element 32.

### Example 1

As in the seventh embodiment, FIG. 47 shows an example of the antenna apparatus configured such that the resonant frequency band of the first antenna element 61 is set to the band (700 to 900 MHz) used by a radio system using LTE, and the resonant frequency band of the second antenna element 62 is set to the band (1.7 to 1.9 GHz) used by a radio system conforming to the 3G standard. Referring to FIG. 47, the numbers show the dimensions (unit: mm) of the respective antenna element portions.

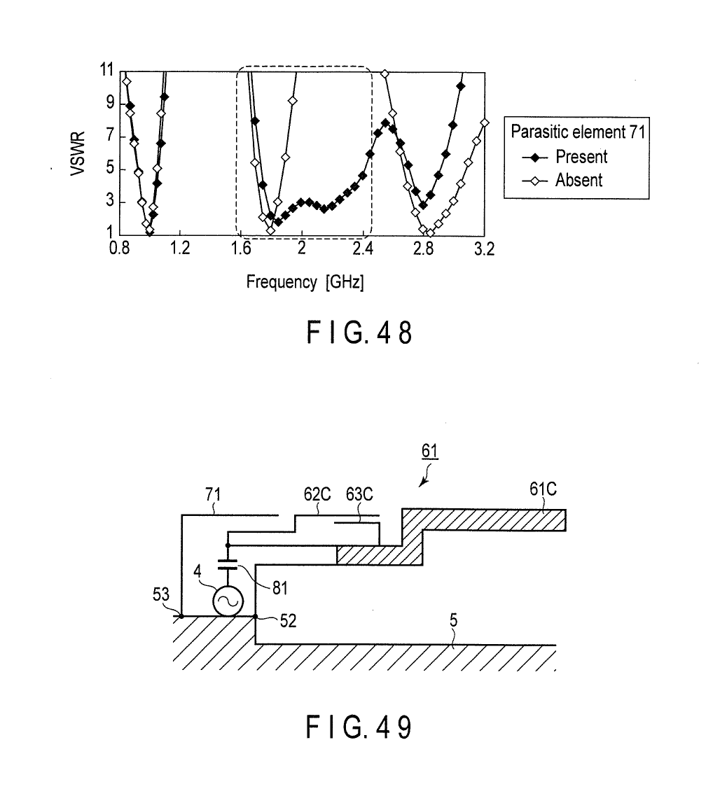

FIG. 48 shows the VSWR frequency characteristic of an example shown in FIG. 47 in comparison with that of an antenna apparatus without the parasitic element 71. As is obvious from FIG. 48, in Example 1 of the ninth embodiment, it is possible to further expand the resonant frequency band of the second antenna element 62 by disposing the parasitic element 71 near the second antenna element 62 so as to allow the parasitic element 71 to be electrostatically coupled to the second antenna element 62.

### Example 2

FIG. 49 shows Example 2 of the antenna apparatus according to the ninth embodiment. Note that in the following description, the same reference numbers as in FIG. 49 denote the same parts in FIG. 46.

This antenna apparatus is configured such that a section extending from a stub 67 of the first antenna element 61 to the folding end is formed from one plate-like element 61C, and an L-shaped branch element 63C is connected between the folded portion of the one plate-like element 61c and the stub. The second antenna element 62 is folded into a crank shape, with its distal end portion being disposed near the horizontal portion of the branch element 63C. In addition, a side of a ground pattern 5 is formed into a stepped shape, and a feed terminal 4 is disposed on the stepped portion. In addition, ground terminals 52 and 53 are arranged on the two sides of the feed terminal 4. The other end (shorting end) of the first antenna element 61 is connected to the ground terminal 52, of the ground terminals 52 and 53, which are disposed on a corner portion of the stepped portion of the ground pattern 5, and the parasitic element 71 is connected to the ground terminal 53. In addition, a lumped parameter element 81 is connected between the feed terminal 4 and a parallel connection point 64 between the first antenna element 61 and a second antenna element 62C. The lumped parameter element 81 is formed from a chip capacitor (for example, 3 pF).

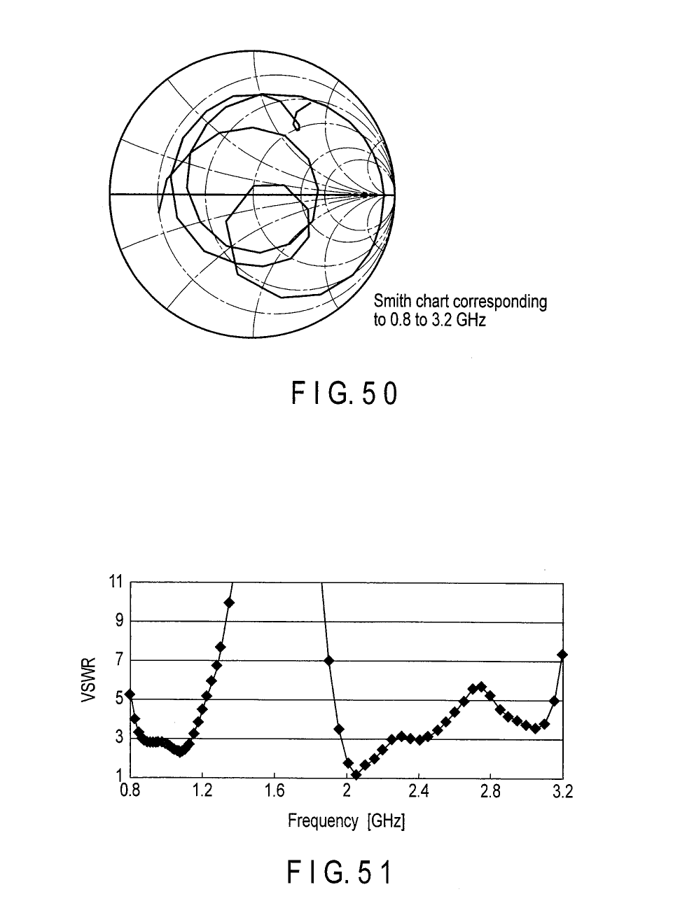

FIG. 50 is a Smith chart showing the antenna characteristics of the antenna apparatus according to Example 2 shown in FIG. 49. FIG. 51 shows the VSWR frequency characteristic of Example 2 shown in FIG. 49. As is obvious from FIGS. 50 and 51, the antenna element shown in FIG. 49 can cover a wide band including a low-frequency band (mainly the 700- to 900-MHz band) and a high-frequency band (mainly the 1.7- to 2.7-GHz band).

### Tenth Embodiment

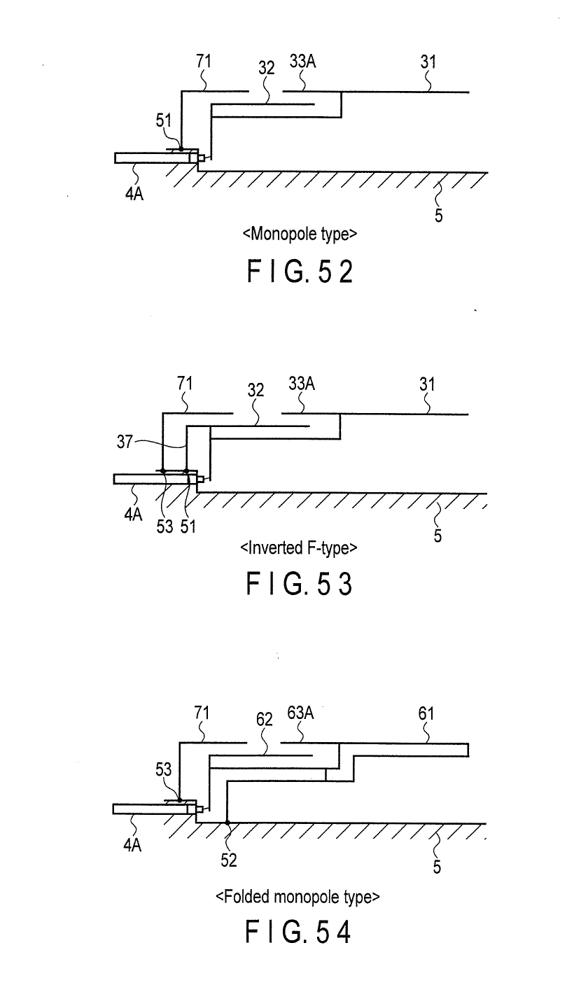

FIG. 52 is a view showing the arrangement of an antenna apparatus (in which the first antenna element 31 is formed from a monopole element) according to the tenth embodiment. Note that the same reference numbers as in FIG. 52 denote the same parts in FIG. 40, and a detailed description of them will be omitted.

Referring to FIG. 52, a side of a ground pattern 5 is formed into a stepped shape, and one end of a parasitic element 71 is connected to a ground terminal 53 provided on the stepped portion. A feed terminal 4 is provided on the vertical portion of the stepped side of the ground pattern 5. A feed cable 4A is wired along the stepped side of the ground pattern 5. The feed cable 4A is connected to the feed terminal 4.

This arrangement allows to linearly wire the feed cable 4A without folding it, thus preventing a deterioration in antenna characteristics due to variations in the wiring route of the feed cable 4A and the like.

### Eleventh Embodiment

FIG. 53 shows the arrangement of an antenna apparatus (in which a first antenna element 31 is formed from an inverted F-type element) according to the eleventh embodiment. Note that the same reference numbers as in FIG. 53 denote the same parts in FIG. 43, and a detailed description of them will be omitted.

Referring to FIG. 53, a side of a ground pattern 5 is formed into a stepped shape as in the tenth embodiment. Ground terminals 51 and 53 are provided on the stepped portion of a side of the ground pattern 5. One end of a shorting element 37 and one end of a parasitic element 71 are respectively connected to the ground terminals 51 and 53. A feed terminal 4 is provided on the vertical portion of the side of the ground pattern 5 which is formed into the stepped shape. A feed cable 4A is wired along the stepped portion of the side of the ground pattern 5 and is connected to the feed terminal 4.

This arrangement allows to linearly wire the feed cable 4A without folding it, thus preventing a deterioration in antenna characteristics due to variations in the wiring route of the feed cable 4A and the like.

### Twelfth Embodiment

FIG. 54 shows the arrangement of an antenna apparatus (in which a first antenna element 61 is formed from a folded monopole element with a stub) according to the twelfth embodiment. Note that the same reference numbers as in FIG. 54 denote the same parts in FIG. 46, and a detailed description of them will be omitted.

Referring to FIG. 54, a side of a ground pattern 5 is formed into a stepped shape as in the tenth and eleventh embodiments. A ground terminal 53 is provided on the stepped portion of the side of the ground pattern 5. One end of a parasitic element 71 is connected to the ground terminal 53. A feed terminal 4 is provided on the vertical portion of the side of the ground pattern 5 which is formed into the stepped shape. A feed cable 4A is wired along the stepped portion of the side of the ground pattern 5. The feed cable 4A is connected to the feed terminal 4.

This arrangement allows to linearly wire the feed cable 4A without folding it, thus preventing a deterioration in antenna characteristics due to variations in the wiring route of the feed cable 4A and the like as in the tenth and eleventh embodiments.

### Other Embodiments

(1) Modifications of First Antenna Element 31

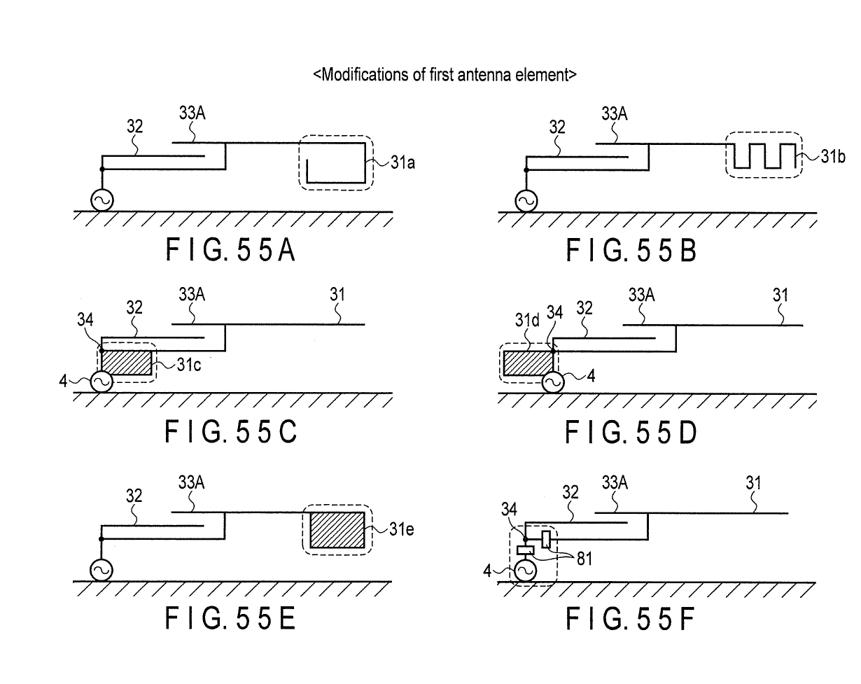

FIGS. 55A, 55B, 55C, 55D, 55E, and 55F show various modifications of the first antenna element 31.

The antenna apparatus shown in FIG. 55A is configured such that a portion of the first antenna element 31 which is located near the open end is folded as indicated by reference number 31a in FIG. 55A.

The antenna apparatus shown in FIG. 55B is configured such that a portion of the first antenna element 31 which is located near the open end is formed into a meander shape as indicated by reference number 31b in FIG. 55B.

The arrangement shown in FIG. 55A or 55B can reduce the installation space in the lengthwise direction of the elements of the antenna apparatus even if the element length of the first antenna element 31 is large.

The antenna apparatuses shown in FIGS. 55C and 55D are configured such that portions 31c and 31d of the first antenna elements 31 which are located near the feed terminals 4 are formed wide.

The antenna apparatus shown in FIG. 55E is configured such that a portion 31e of the first antenna element 31 which is located near the open end is formed wide.

The antenna apparatus shown in FIG. 55F is configured such that lumped parameter elements 81 are respectively connected between the feed terminal 4 of the first antenna element 31 and the parallel connection point 34 and between the parallel connection point 34 and the branching point 35.

(2) Modifications of Second Antenna Element 32

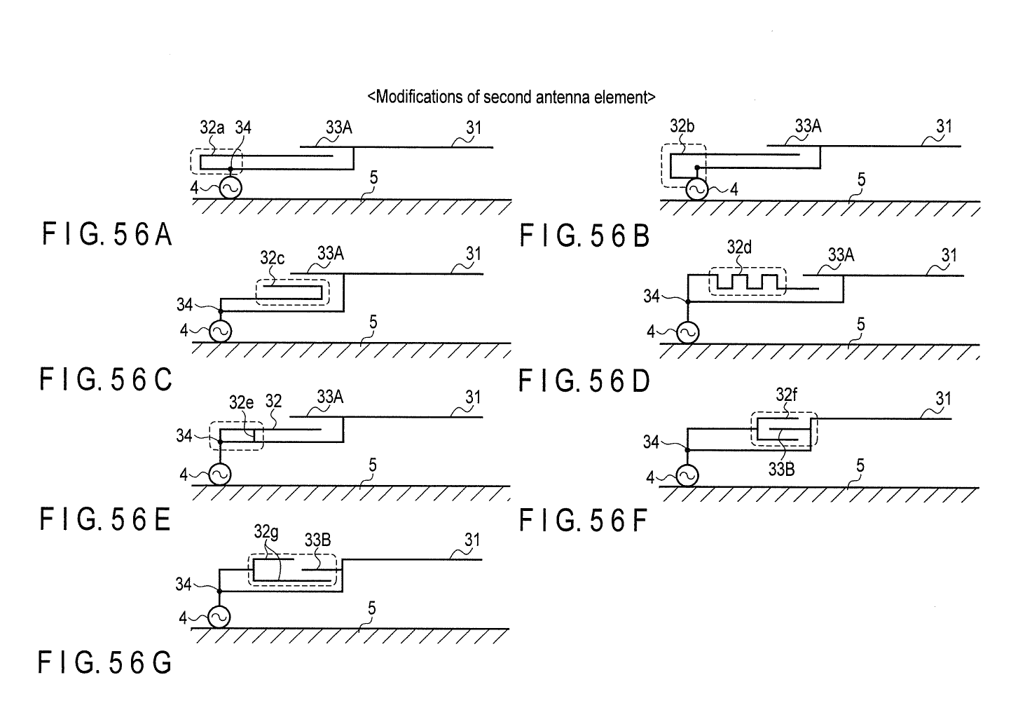

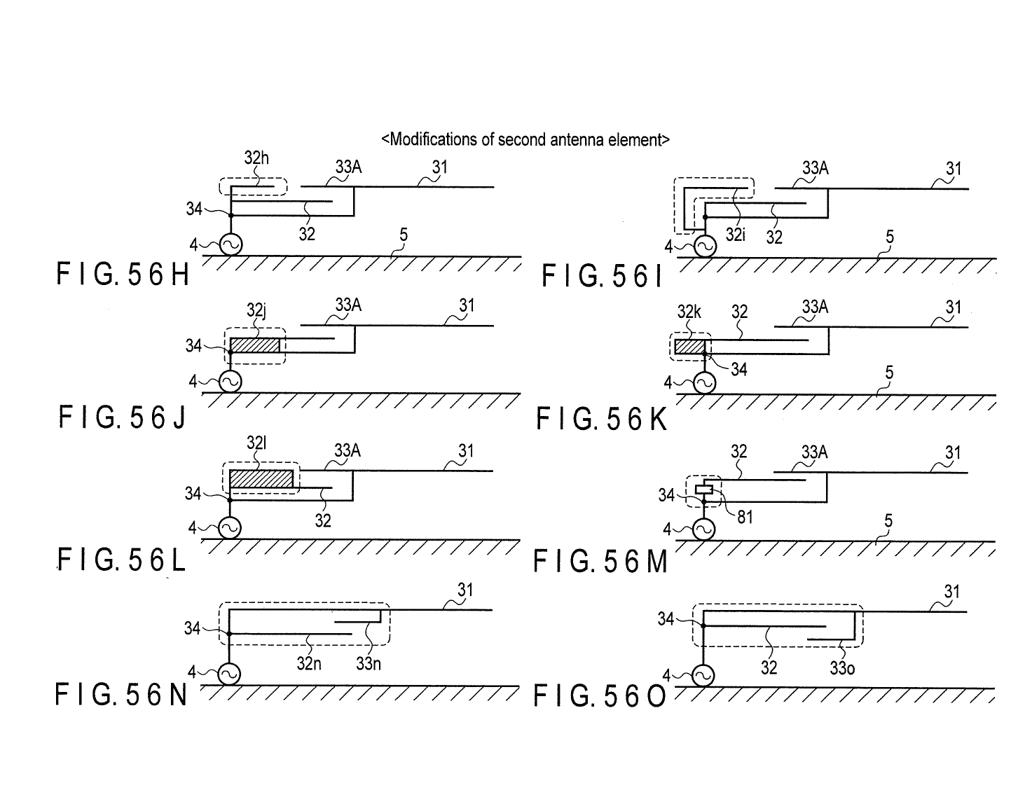

FIGS. 56A, 56B, 56C, 56D, 56E, 56F, 56G, 56H, 56I, 56J, 56K, 56L, 56M, 56N, and 56O show various modifications of the second antenna element 32.

The antenna apparatus shown in FIG. 56A is configured such that one end of the second antenna element 32 is connected to the parallel connection point 34 of the first antenna element 31 in a direction opposite to the folding direction of the first antenna element 31, and the intermediate portion is folded, as indicated by reference number 32a in FIG. 56A.

The antenna apparatus shown in FIG. 56B is configured such that one end of the second antenna element 32 is directly connected to the feed terminal 4, and an intermediate portion is folded, as indicated by reference number 32b in FIG. 56B.

The antenna apparatus shown in FIG. 56C is configured such that an open end portion of the second antenna element 32 is folded at an intermediate position.

The antenna apparatus shown in FIG. 56D is configured such that an intermediate portion of the second antenna element 32 is formed into a meander shape, as indicated by reference number 32d in FIG. 56D.

The antenna apparatus shown in FIG. 56E is configured such that an intermediate position of the second antenna element 32 is connected to an intermediate position of the first antenna element 31 through a shorting element 32e.

The antenna apparatuses shown in FIGS. 56F and 56G each are configured such that a section extending from an intermediate portion of the second antenna element 32 to the open end is made to branch into two elements, and both or one of the two elements are disposed to face the branch element 33B, as indicated by reference number 32f or 32g in FIG. 56F or 56G.

The antenna apparatuses shown in FIGS. 56H and 56I each are configured such that at least one (one in FIG. 56H or 56I) element 32h or 32i is connected in parallel to the second antenna element 32.

The antenna apparatuses shown in FIGS. 56J and 56K each are configured such that a portion near the connection point between the second antenna element 32 and the first antenna element 31 is formed into a wide plate-like shape, as indicated by reference number 32j or 32k in FIG. 56J or 56K.

The antenna apparatus shown in FIG. 56L is configured such that a portion extending from the proximal end of the second antenna element 32 to an intermediate position is formed into a wide plate-like shape, as indicated by reference number 32l in FIG. 56L.

The antenna apparatus shown in FIG. 56M is configured such that the lumped parameter element 81 is connected in an element of the second antenna element 32.

The antenna apparatus shown in FIG. 56N is configured such that the second antenna element 32 is disposed between the first antenna element 31 and the ground pattern 5, and a branch element 33n is disposed between the first antenna element 31 and the second antenna element 32.

The antenna apparatus shown in FIG. 56O is configured such that the second antenna element 32 is disposed between the first antenna element 31 and the ground pattern 5, and the branch element 33n is disposed between the second antenna element 32 and the ground pattern 5.

(3) Modifications of Branch Element 33

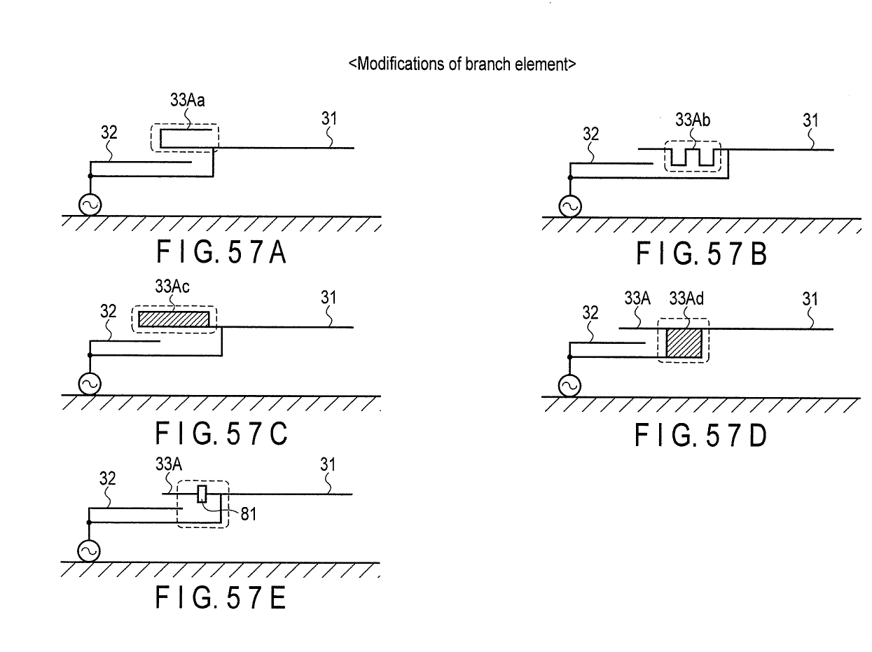

FIGS. 57A, 57B, 57C, 57D, and 57E show various modifications of the branch element 33.

The antenna apparatus shown in FIG. 57A is configured such that the branch element 33A is folded at its intermediate position, as indicated by reference number 33Aa in FIG. 57A.

The antenna apparatus shown in FIG. 57B is configured such that an intermediate portion of the branch element 33A is formed into a meander shape, as indicated by reference number 33Ab in FIG. 57B.

The antenna apparatus shown in FIG. 57C is configured such that a section extending from an intermediate position of the branch element 33A to the distal end is formed into a wide plate-like shape, as indicated by reference number 33Ac in FIG. 57C.

The antenna apparatus shown in FIG. 57D is configured such that a connection portion of the branch element 33A with respect to the first antenna element 31 is formed wide, as indicated by reference number 33Ad in FIG. 57D.

The antenna apparatus shown in FIG. 57E is configured such that the lumped parameter element 81 is connected in an element of the branch element 33A.

(4) Modifications of Inverted F-Type Antenna Element

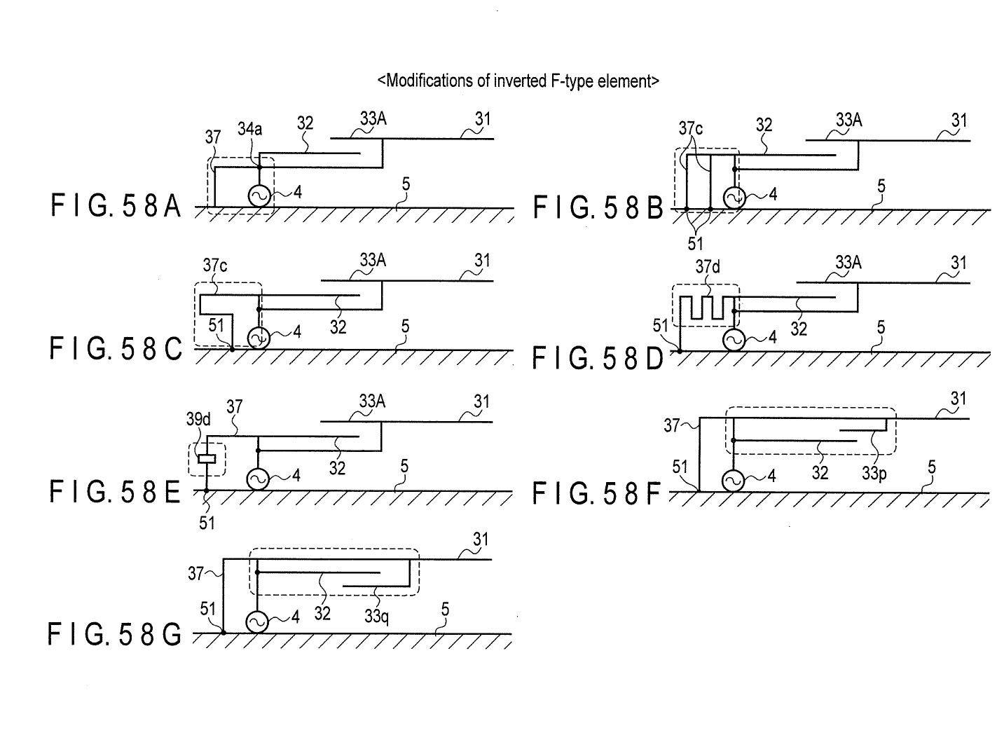

FIGS. 58A, 58B, 58C, 58D, 58E, 58F, and 58G show various modifications of the inverted F-type antenna element.

The antenna apparatus shown in FIG. 58A is configured such that a shorting element 71 is connected between the ground terminal 53 and a parallel connection point 34a between the first antenna element 31 and the second antenna element 32.

The antenna apparatus shown in FIG. 58B is configured such that a plurality of (two in FIG. 58B) shorting elements 71a and 71b are connected in parallel to the first antenna element 31.

The antenna apparatus shown in FIG. 58C is configured such that the shorting element 71 is folded, as indicated by reference number 71c in FIG. 58C.

The antenna apparatus shown in FIG. 58D is configured such that an intermediate portion of the shorting element 71 is formed into a meander shape, as indicated by reference number 71d in FIG. 58D.

The antenna apparatus shown in FIG. 58E is configured such that the lumped parameter element 81 is connected in an element of the shorting element 71.

The antenna apparatus shown in FIG. 58F is configured such that the second antenna element 32 is disposed between the first antenna element 31 and the ground pattern 5, and a branch element 33p is disposed between the first antenna element 31 and the second antenna element 32.

The antenna apparatus shown in FIG. 58G is configured such that the second antenna element 32 is disposed between the first antenna element 31 and the ground pattern 5, and a branch element 33q is disposed between the second antenna element 32 and the ground pattern 5.

(5) Modifications of Folded Antenna Element

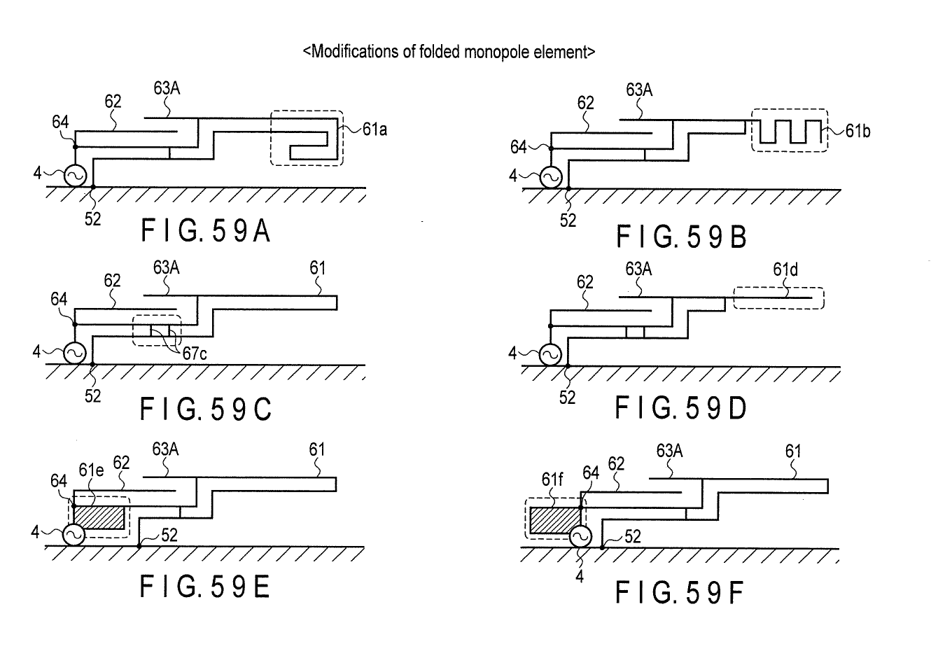

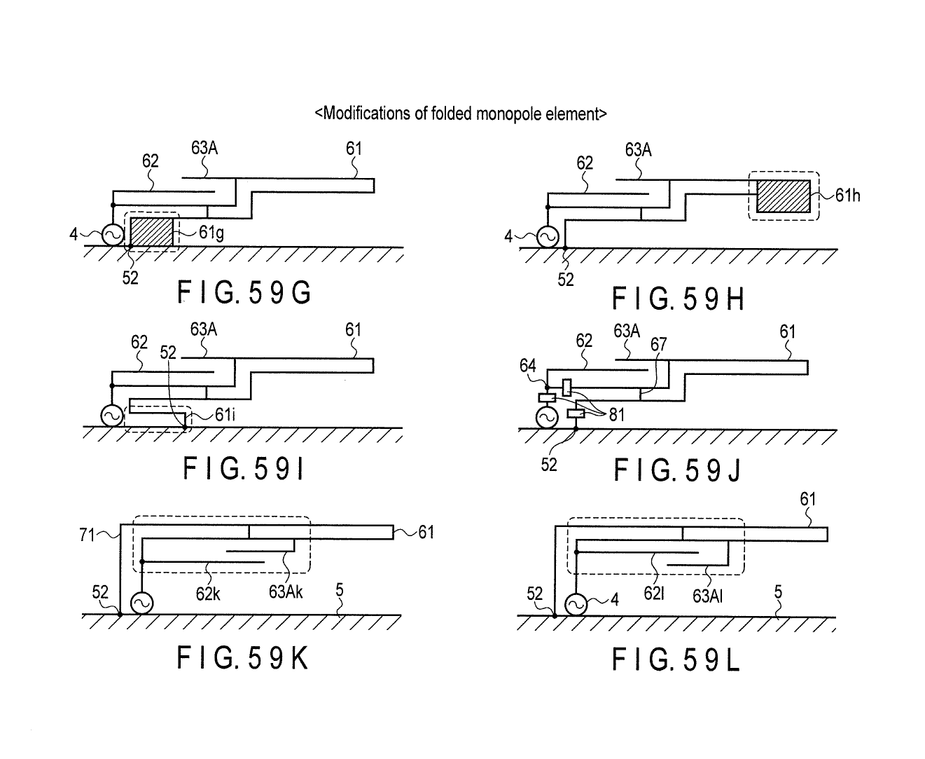

FIGS. 59A, 59B, 59C, 59D, 59E, 59F, 59G, 59H, −59I, 59J, 59K, and 59L show various modifications of the first antenna element 61 formed from the folded monopole element with the stub.

The antenna apparatus shown in FIG. 59A is configured such that the distal end portion of the first antenna element 61 is folded, as indicated by reference number 61a in FIG. 59A.

The antenna apparatus shown in FIG. 59B is configured such that the distal end portion of the first antenna element 61 is formed from one element and formed into a meander shape, as indicated by reference number 61b in FIG. 59B.

The antenna apparatus shown in FIG. 59C is configured such that a plurality of stubs 67c are provided at intermediate positions of the first antenna element 61.

The antenna apparatus shown in FIG. 59D is configured such that the distal end portion of the first antenna element 61 is formed from one element, as indicated by reference number 61d in FIG. 59D.

The antenna apparatuses shown in FIGS. 59E and 59F each are configured such that a portion of the first antenna element 61 which is located near the feed terminal 4 is formed into a wide plate-like shape, as indicated by reference number 61 in FIG. 59E or 59F.

The antenna apparatus shown in FIG. 59G is configured such that a portion of the first antenna element 61 which is located near the ground terminal is formed into a wide plate-like shape, as indicated by reference number 61g in FIG. 59G.

The antenna apparatus shown in FIG. 59H is configured such that the distal end portion of the first antenna element 61 is formed into a wide plate-like portion 61h.

The antenna apparatus shown in FIG. 59I is configured such that the other end portion of the first antenna element 61 is folded into a crank shape, and its distal end is connected to the ground terminal 52 provided at a position spaced away from the feed terminal 4. That is, the ground point of the folded monopole element 61 with the stub with respect to the ground pattern 5 is offset.

The antenna apparatus shown in FIG. 59J is configured such that the lumped parameter elements 81 are respectively connected between the parallel connection point 64 and the feed terminal 4 of the first antenna element 61, between the parallel connection point 64 and a branching point 65, and between the connection position of the stub 67 and the ground terminal 52.

The antenna apparatus shown in FIG. 59K is configured such that a second antenna element 62k is disposed between the first antenna element 61 and the ground pattern 5, and a branch element 63Ak is disposed between the first antenna element 61 and the second antenna element 62k.

The antenna apparatus shown in FIG. 59L is configured such that a second antenna element 62l is disposed between the first antenna element 61 and the ground pattern 5, and a branch element 63Al is disposed between the second antenna element 62l and the ground pattern 5.

(6) Other Modifications

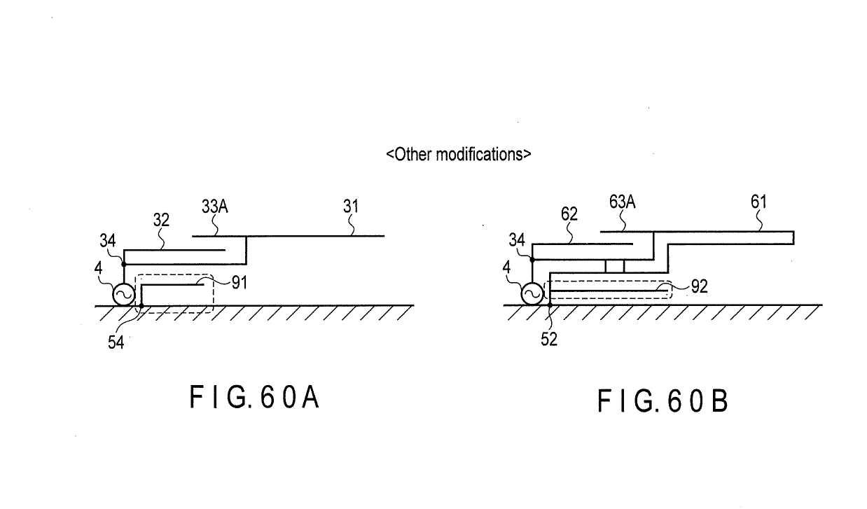

The antenna apparatus shown in FIG. 60A is configured such that a parasitic element 91 is disposed between the first antenna element 31 and the ground pattern 5. The parasitic element 91 is directly connected to a ground terminal 54 provided on the ground pattern 5.

The antenna apparatus shown in FIG. 60B is configured such that a parasitic element 92 is disposed between the ground pattern 5 and the first antenna element 61 formed from the folded element. The proximal end of the parasitic element 92 is connected to a portion of the first antenna element which is located near the ground terminal 52.

The embodiments can be executed by variously modifying the shapes, installation positions, and sizes of a folded monopole element with a stub, monopole element, and parasitic element and the types, arrangements, and the like of electronic devices.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An antenna apparatus connected to a feed terminal, the apparatus comprising:
a first antenna element including one end connected to the feed terminal, and an other end open, with an element length from the feed terminal to the other end being set to substantially ¼ a wavelength corresponding to a preset first resonant frequency;
a second antenna element including one end connected to a first position set on an element of the first antenna element, and an other end open, a portion between the one end and the other end being disposed parallel to the first antenna element, and an element length from the feed terminal to the other end through the first position being set to substantially ¼ a wavelength corresponding to a preset second resonant frequency; and
a third antenna element including one end connected to a second position set between the other end and the first position on an element of the first antenna element, and an other end open, with at least part of a portion between the one end and the other end being disposed near the second antenna element.

2. The apparatus of claim 1, further comprising a shorting element including one end connected to a third position set on an element of one of the first antenna element and the second antenna element, and other end connected to a first ground terminal, with a portion from the one end to the other end being disposed parallel to one of the first antenna element and the second antenna element.

3. An antenna apparatus connected to a feed terminal and a first ground terminal provided on a ground pattern, the apparatus comprising:
a first antenna element formed from a folded monopole element including one end connected to the feed terminal, and the other end connected to the first ground terminal, and including a stub provided between a forward portion and a backward portion which are formed by folding an intermediate portion, with an electrical length from the feed terminal to the first ground terminal through the forward portion and the backward portion being set to substantially ½ a wavelength corresponding to a present first resonant frequency;
a second antenna element including one end connected to a first position set on an element of the first antenna element, and an other open, with a portion between the one end the other end being disposed parallel to the first antenna element, and an element length from the feed terminal to the other end through the first position being set to substantially ¼ a wavelength corresponding to a present second resonant frequency; and
a third antenna element including one end connected to a second position set between the other end and the first position set on the element of the first antenna element, and an other end open, with at least part of a portion between the one end and the other end being disposed near the second antenna element.

4. The apparatus of claim 1, wherein the first resonant frequency is set to be lower than the second resonant frequency.

5. The apparatus of claim 3, wherein the first resonant frequency is set to be lower than the second resonant frequency.

6. The apparatus of claim 3, wherein a distance between the feed terminal and the first ground terminal is set to substantially not more than ⅕ a wavelength corresponding to the first resonant frequency.

7. The apparatus of claim 3, wherein a section from an installation position of the stub on the forward portion and the backward portion of the first antenna element to a folding end is formed from one linear element or a plate-like element.

8. The apparatus of claim 1, further comprising a fourth antenna element formed from a parasitic element including one end connected to the ground terminal, and an other end open, with at least part of the parasitic element being disposed parallel to the second antenna element so as to be capacitively coupled to the second antenna element.

9. The apparatus of claim 3, further comprising a fourth antenna element formed from a parasitic element including one end connected to a second ground terminal provided on the ground pattern, and an other end open, with at least part of the parasitic element being disposed parallel to the second antenna element so as to be capacitively coupled to the second antenna element.

10. The apparatus of claim 8, further comprising:
a printed circuit board including a first area where conductive patterns of the first antenna element, the second antenna element, the third antenna element, the fourth antenna element and the feed terminal are formed, and a second area where a ground pattern including part of a side formed into a substantially crank shape, the first ground terminal, and the second ground terminal are formed; and
a feed cable with a distal end portion of a conductive line being disposed on the second area so as to protrude from the side formed into the crank shape to the first area, and the protruding distal end portion of the conductive line being connected to the feed terminal formed in the first area.

11. The apparatus of claim 9, further comprising:
a printed circuit board including a first area where conductive patterns of the first antenna element, the second antenna element, the third antenna element, the fourth antenna element and the feed terminal are formed, and a second area where the ground pattern including part of a side formed into a substantially crank shape, the first ground terminal, and the second ground terminal are formed; and
a feed cable with a distal end portion of a conductive line being disposed on the second area so as to protrude from the side formed into the crank shape to the first area, and the protruding distal end portion of the conductive line being connected to the feed terminal formed in the first area.

12. An electrical device comprising:
a radio unit configured to transmit and receive a radio signal; and
an antenna apparatus connected to the radio unit via a feed terminal,
the antenna apparatus comprising
a first antenna element including one end connected to the feed terminal, and an other end open, with an element length from the feed terminal to the other end being set to substantially ¼ a wavelength corresponding to a preset first resonant frequency,
a second antenna element including one end connected to a first position set on an element of the first antenna element, and an other end open, a portion between the one end and the other end being disposed parallel to the first antenna element, and an element length from the feed terminal to the other end through the first position being set to substantially ¼ a wavelength corresponding to a preset second resonant frequency, and
a third antenna element including one end connected to a second position set between the other end and the first position on an element of the first antenna element, and an other end open, with at least part of a portion between the one end and the other end being disposed near the second antenna element.

13. The device of claim 12, wherein the antenna apparatus further comprises a shorting element including one end connected to a third position set on an element of one of the first or second antenna element, and other end connected to a ground terminal, with a portion from the one end to the other end being disposed parallel to one of the first or second antenna element.

14. An electronic device comprising:
a radio unit configured to transmit and receive a radio signal; and
an antenna apparatus connected to the radio unit via a feed terminal and a first ground terminal provided on a ground pattern,
the antenna apparatus comprising
a first antenna element formed from a folded monopole element including one end connected to the feed terminal, and an other end connected to the first ground terminal, and including a stub provided between a forward portion and a backward portion which are formed by folding an intermediate portion, with an electrical length from the feed terminal to the first ground terminal through the forward portion and the backward portion being set to substantially ½ a wavelength corresponding to a present first resonant frequency,
a second antenna element including one end connected to a first position set on an element of the first antenna element, and an other open, with a portion between the one end the other end being disposed parallel to the first antenna element, and an element length from the feed terminal to the other end through the first position being set to substantially ¼ a wavelength corresponding to a present second resonant frequency, and
a third antenna element including one end connected to a second position set between the other end and the first position set on the element of the first antenna element, and an other end open, with at least part of a portion between the one end and the other end being disposed near the second antenna element.
